(19) United States
(12) Patent Application Publication
(10) Pub. No.: US 2026/0278960 A1
(43) Pub. Date: Sep. 17, 2026

(54) ARCHITECTURES COMBINING AUGMENTED REALITY AND VIRTUAL REALITY OR OTHER REMOTE APPLICATIONS TO FACILITATE INTERACTIONS WITH THE VIRTUAL WORLD AND PHYSICAL WORLD

(71) Applicant: The Aerospace Corporation, El Segundo, CA (US)

(72) Inventor: Trevor M. JAHN, Marina Del Rey, CA (US)

(73) Assignee: The Aerospace Corporation, El Segundo, CA (US)

(21) Appl. No.: 19/672,880

(22) Filed: May 11, 2026

Related U.S. Application Data
(63) Continuation-in-part of application No. 18/452,129, filed on Aug. 18, 2023.

(51) Int. Cl. G06T 19/00; G06T 13/20; G06T 19/20; G06V 20/70

(52) U.S. Cl. CPC G06T 19/006; G06T 13/20; G06T 19/003; G06T 19/20; G06V 20/70; G06T 2219/2004; G06T 2219/2016

(57) ABSTRACT

Architectures combining augmented reality (AR) and remote functionality (such as virtual reality (VR)) facilitate interactions with the virtual world and physical world. A three dimensional (3D) model of the real world is used to enable remote computing system users (e.g., scientists, engineers, etc.) to communicate with AR explorers (e.g., astronauts, divers, etc.) using holograms and/or track their progress.

### CROSS-REFERENCE TO RELATED APPLICATION

This application is a continuation-in-part of, and claims priority to, U.S. patent application Ser. No. 18/452,129 filed on Aug. 18, 2023. The subject matter of this earlier filed application is incorporated by reference in its entirety.

### FIELD

The present invention generally relates to electronics and artificial intelligence, and more specifically, to architectures combining augmented reality (AR) and virtual reality (VR) or other remote applications to facilitate interactions with the virtual world and physical world.

### BACKGROUND

AR and VR technologies exist that allow collaboration between multiple users in a virtual world. Global positioning system (GPS) coordinates may be used for object locations in AR, and annotations may be used in combined AR and VR systems. However, the annotations and markers are not common to both the AR and VR environments, nor are voice or video annotations provided. Furthermore, existing technologies lack a feedback loop between users working in AR and VR in tandem. Accordingly, an improved and/or alternative approach to combined AR and VR systems may be beneficial.

### SUMMARY

Certain embodiments of the present invention may provide solutions to the problems and needs in the art that have not yet been fully identified, appreciated, or solved by current augmented reality and virtual reality technologies. For example, some embodiments of the present invention pertain to architectures combining AR and VR or other remote applications to facilitate interactions with the virtual world and physical world.

In an embodiment, one or more non-transitory computer-readable media store one or more computer programs for a remote application for a combined augmented AR and remote system. The one or more computer programs are configured to cause at least one processor to render a three-dimensional (3D) digital twin of a location that an AR explorer either is currently visiting or previously visited and display one or more holograms pertaining to the location. The one or more holograms are placed by at least one of the AR explorer and a virtual user. The one or more computer programs are also configured to cause the at least one processor to represent the AR explorer in the 3D digital twin using an avatar and play movement of the avatar by showing a path taken by the AR explorer and a direction in which the AR explorer was looking at various times during the recording.

In another embodiment, a computer-implemented method for a remote application of a combined AR and remote system includes rendering a 3D digital twin of a location that an AR explorer either is currently visiting or previously visited and displaying one or more holograms pertaining to the location, the one or more holograms placed by at least one of the AR explorer and a virtual user, by a computing system. The computer-implemented method also includes representing the AR explorer in the 3D digital twin using an avatar playing movement of the avatar by showing a path taken by the AR explorer and a direction in which the AR explorer was looking at various times during the recording, by the computing system. The computer-implemented method further includes displaying alignment options comprising at least one of rotation controls and translation controls and performing at least one of rotation and translation responsive to manipulation of the rotation controls and/or translation controls by the remote user, by the computing system.

In yet another embodiment, one or more computing systems include memory storing computer program instructions for a remote application of a combined AR and remote system and at least one processor configured to execute the computer program instructions. The computer program instructions are configured to cause the at least one processor to render a 3D digital twin of a location that an AR explorer either is currently visiting or previously visited and display one or more holograms pertaining to the location, the one or more holograms placed by at least one of the AR explorer and a virtual user. The computer program instructions are also configured to cause the at least one processor to represent the AR explorer in the 3D digital twin using an avatar and play movement of the avatar by showing a path taken by the AR explorer and a direction in which the AR explorer was looking at various times during the recording.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIGS. 1A-C are computer-modeled images illustrating explorers using the AR capabilities of a combined AR and remote system, according to an embodiment of the present invention.

FIGS. 2A-C are computer-modeled images illustrating a location tracking interface of a VR portion of a combined AR and remote system, according to an embodiment of the present invention.

FIG. 3 illustrates messages from a remote user and an AR explorer, according to an embodiment of the present invention.

FIGS. 4A-J are computer-modeled images illustrating a remote user interface of a combined AR and remote system, according to an embodiment of the present invention.

FIG. 5 is a graph of an AR explorer path, according to an embodiment of the present invention.

FIGS. 6A-F illustrate a user interface of an AR smart phone application that allows an AR explorer to place and edit annotated holograms and share them with remote users as well, according to an embodiment of the present invention.

FIG. 7 is an architectural diagram illustrating a system configured to provide combined AR and VR with a feedback loop, according to an embodiment of the present invention.

FIG. 8A is a screenshot illustrating an AR explorer interface, according to an embodiment of the present invention.

FIG. 8B illustrates an AR explorer map that may be superimposed over the real world, according to an embodiment of the present invention.

FIG. 8C is a screenshot illustrating a View List interface that displays a list of annotations in the current session, according to an embodiment of the present invention.

FIG. 8D is a screenshot illustrating a root annotation rotation and scaling interface where the AR explorer can change the location of proximate annotations zooming in or out and/or rotating the annotations based on a root annotation, according to an embodiment of the present invention.

FIG. 9A is a screenshot illustrating a VR user interface, according to an embodiment of the present invention.

FIG. 9B illustrates the VR user interface with an annotation, according to an embodiment of the present invention.

FIG. 10A illustrates an example of a neural network that has been trained to augment AR and/or VR, according to an embodiment of the present invention.

FIG. 10B illustrates an example of a neuron, according to an embodiment of the present invention.

FIG. 11 is a flowchart illustrating a process for training AI/ML model(s), according to an embodiment of the present invention.

FIG. 12 is an architectural diagram illustrating a computing system configured to provide combined AR and/or VR with a feedback loop, or aspects thereof, according to an embodiment of the present invention.

FIG. 13 is a flowchart illustrating a process for providing combined AR and VR with a feedback loop, or aspects thereof, according to an embodiment of the present invention.

FIG. 14 is a flowchart illustrating a process for providing AR with a feedback loop, or aspects thereof, according to an embodiment of the present invention.

FIG. 15 is a flowchart illustrating a process for providing VR with a feedback loop, or aspects thereof, according to an embodiment of the present invention.

FIGS. 16A and 16B are flowcharts illustrating a process for using a remote application of a combined AR and remote system configured to facilitate interactions with the virtual world and physical world, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to architectures combining AR and remote functionality (e.g., VR or another remote application) to facilitate interactions with the virtual world and physical world. A three dimensional (3D) model of the real world is used to enable remote computing system users (e.g., scientists, engineers, etc.) to communicate with AR explorers (e.g., astronauts, divers, etc.) using holograms and/or track their progress. Biform communication is provided through AR and remote applications in some embodiments. Location and field of view tracking can be provided without a global navigation satellite system (GNSS), such as global positioning system (GPS) technology.

There are multiple ways someone can track their change in position in 3D space. On Earth, electronic devices use a combination of accelerometers and magnetometers to detect movement and direction, respectively. The accelerometers and magnetometers can also be used in either an AR/VR headset or a smart phone (or tablet, laptop, smart watch, etc.). As such, some embodiments including such hardware can operate on Earth, in low Earth orbit (LEO), or anywhere else an electromagnetic field is present. A magnetometer uses the electromagnetic field like a digital compass. It should be noted, however, that there are other possible ways to measure the change in direction and orientation in 3D space. Examples of other methods for tracking changes in position include, but are not limited to, inertial measurement units (IMUs), optical/computer vision tracking, radio frequency (RF)-based tracking, light detection and ranging (LiDAR), etc. These other techniques could work on the moon, Mars, etc.

Some embodiments “augment” GNSS. When the location of the 3D digital twin of the real world is known, the real and virtual twin are aligned. Through coordinate translation, the location of the explorer relative to the 3D digital twin and the location of the explorer relative to GNSS coordinates can be calculated. For example, if there is a 3D digital twin of the Eiffel Tower, the GNSS coordinates of any part of the 3D digital twin are known, and the explorer is standing next to the Eiffel Tower in the real world, if he or she is using such an embodiment, then the 3D digital twin of the real world can be aligned to overlap the real world version. The location/position and change of position of the explorer relative to the 3D digital twin are known through one of the techniques discussed above. Therefore, the GNSS coordinates of the explorer can be understood because the 3D digital twin has GNSS locations associated therewith.

Using a 3D model of the real world, remote computing system users (e.g., VR users or remote users of a non-VR application) communicate with AR explorers via holograms. It should be noted that VR is suggestive of a “first person” point of view. However, a computer interface is used instead of a VR headset in some embodiments. For instance, a non-VR computer application could be used by scientists and the like instead of a VR application.

Location and field of view tracking may also be provided to give the remote computing system users a clearer picture of where the AR explorers are, what they are looking at, etc. Hologram messages may also be exchanged between remote computing system users and AR explorers. Position data tracking may also be provided in some embodiments. In certain embodiments, biometrics are tracked, such as heart rate, body temperature, etc. In certain embodiments, a heat map of the interior of a structure is generated and displayed so remote computing system users can see what AR explorers were looking at the most, where they were standing the most, etc.

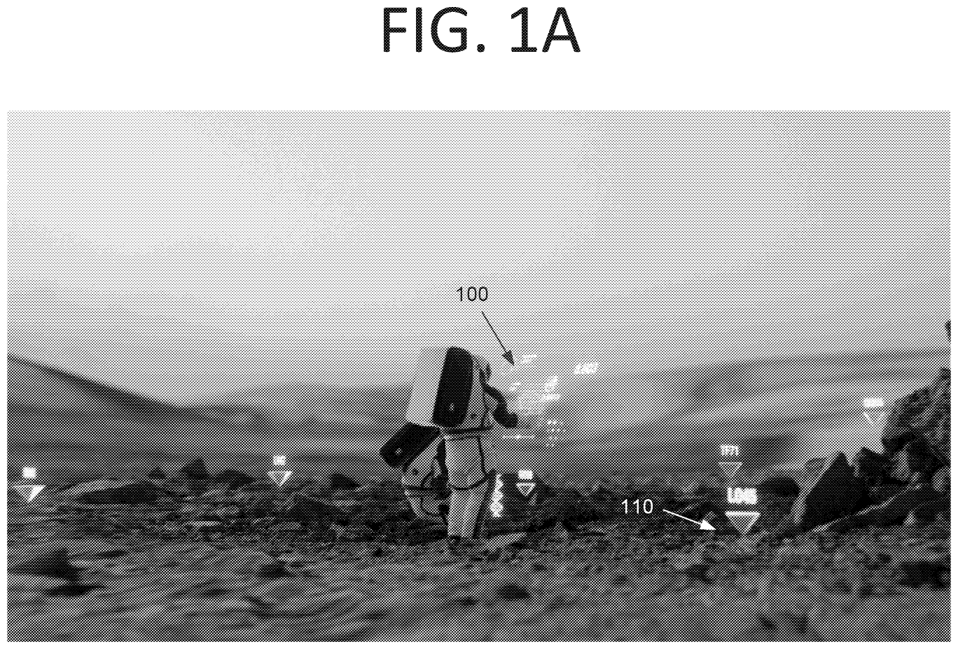

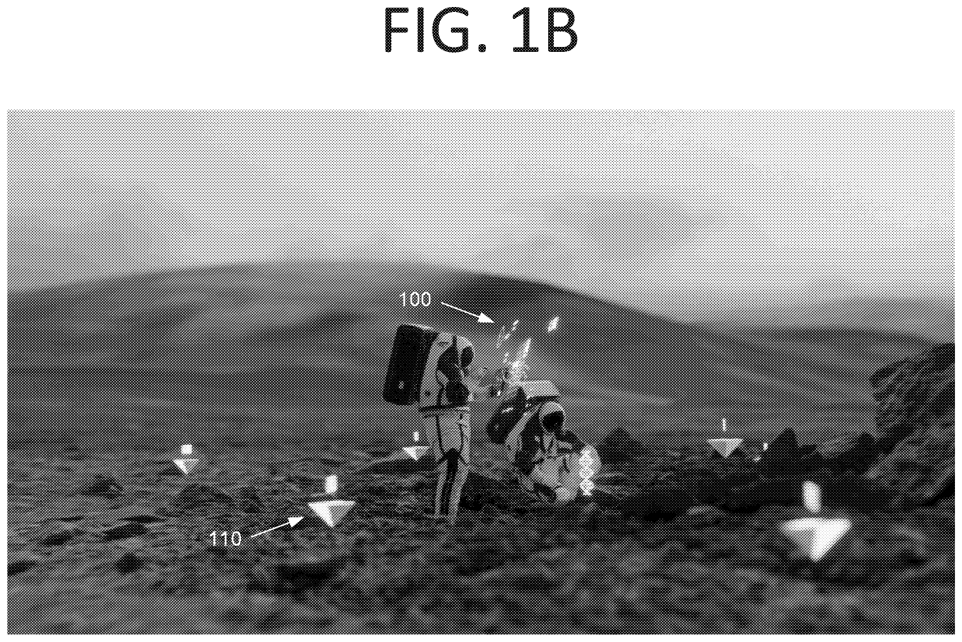

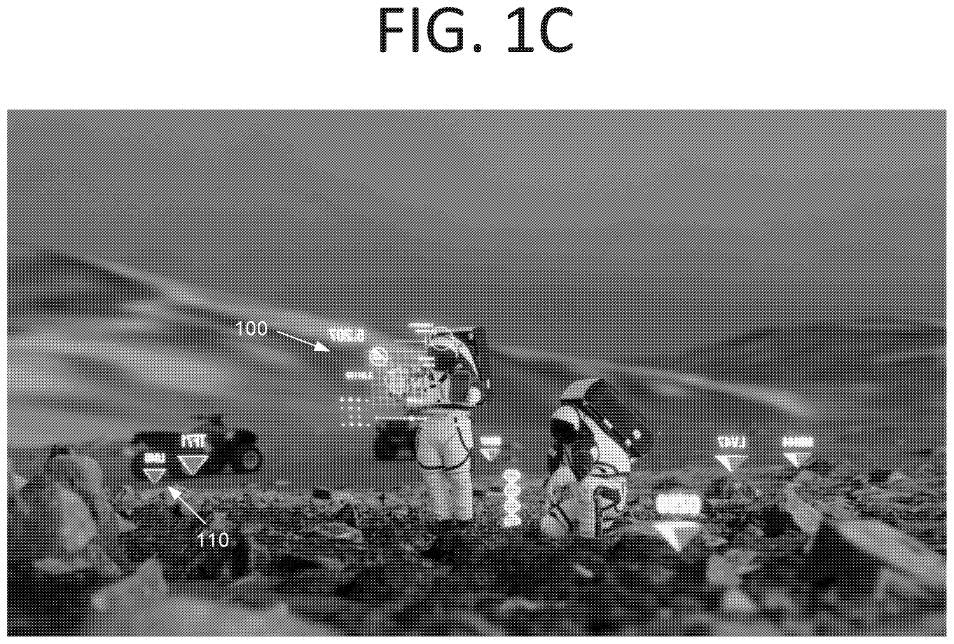

FIGS. 1A-C are computer-modeled images illustrating explorers using the AR capabilities of a combined AR and remote system, according to an embodiment of the present invention. A holographic AR interface 100 allows the explorers to take advantage of the system's AR capabilities, such as look at maps, review comments from remote personnel (e.g., remote computing system users), update labels and statuses, etc. Markers 110 may be placed by AR explorers or remote users, and are visible to the explorers in the physical world via holograms. The virtual world and real world coordinates for markers 110 are synced such that they both share the correct corresponding location in virtual and real space. Markers 110 may display text, point to physical objects, have animations, etc.

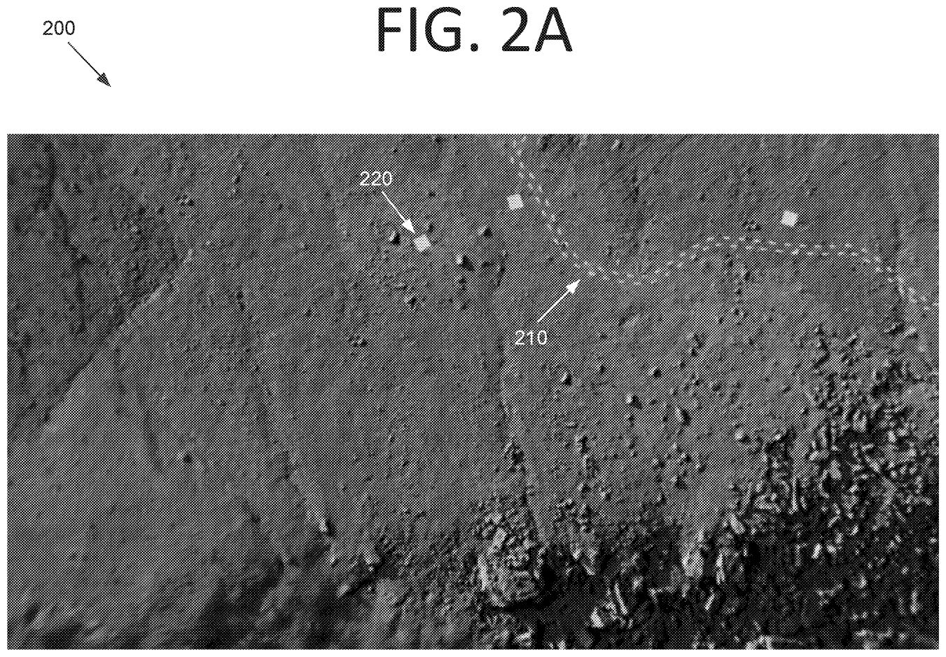

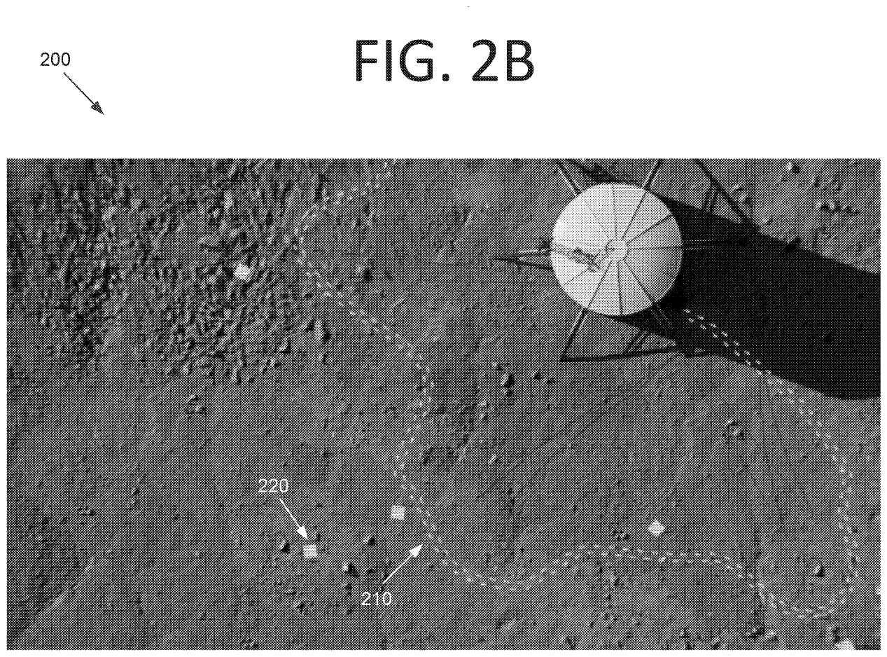

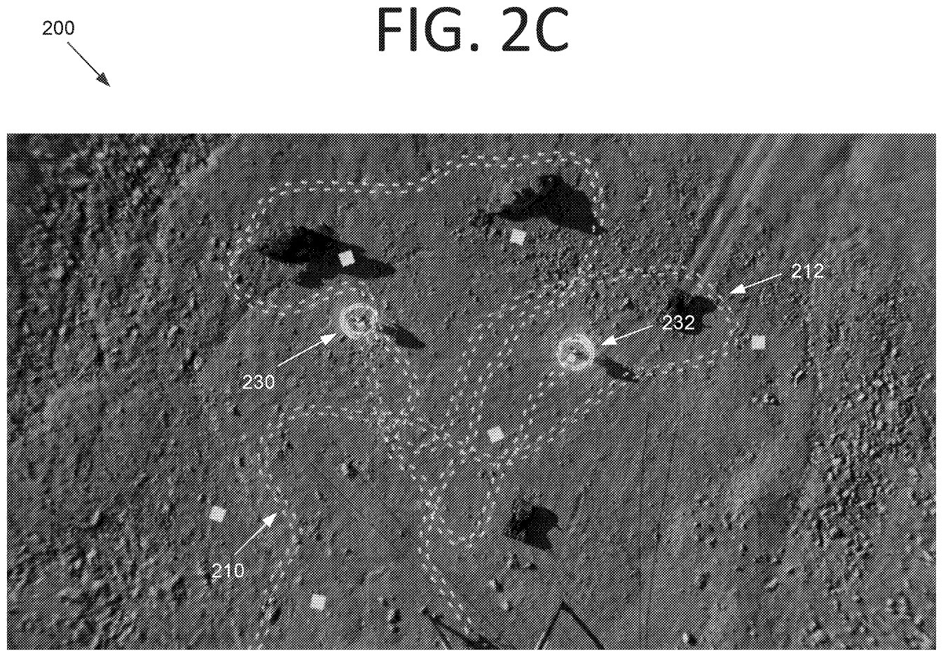

Per the above, location and field of view tracking is provided in some embodiments. FIGS. 2A-C are computer-modeled images illustrating a location tracking interface 200 of a remote portion of a combined AR and remote system, according to an embodiment of the present invention. Referring to FIG. 2A, location tracking interface 200 displays a path 210 that a first explorer took and objects of interest 220. Referring to FIG. 2B, as the remote user moves the map in location tracking interface 200 from southwest to northeast, more of path 210 is visible. Referring to FIG. 2C, the remote user has further moved the map from southwest to northeast, and a second path 212 that a second explorer took is not visible. Also, locations 230, 232 of the first explorer and second explorer, respectively, are visible.

It should be noted that this feature may also be accessible by the AR explorers, and not just remote users. The explorers can pull up the 3D trail of other explorers and see where they have been in AR. When they do this, the avatar of other explorers may also be shown in AR. In other words, the avatar can overlay over the actual person it represents in real time, as well in AR.

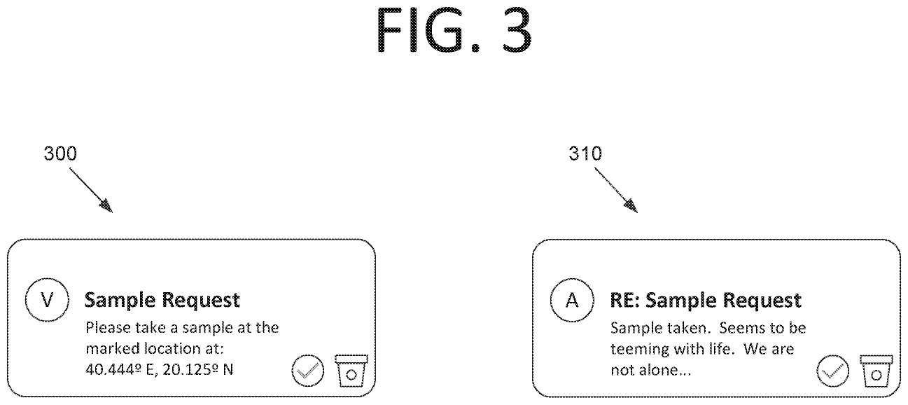

AR explorers and remote users can exchange messages in some embodiments. FIG. 3 illustrates messages 300, 310 from a remote user and an AR explorer, respectively, according to an embodiment of the present invention. The AR explorer can see various messages and respond to them, and the remote user sees similar content in the remote interface, whether VR or another application.

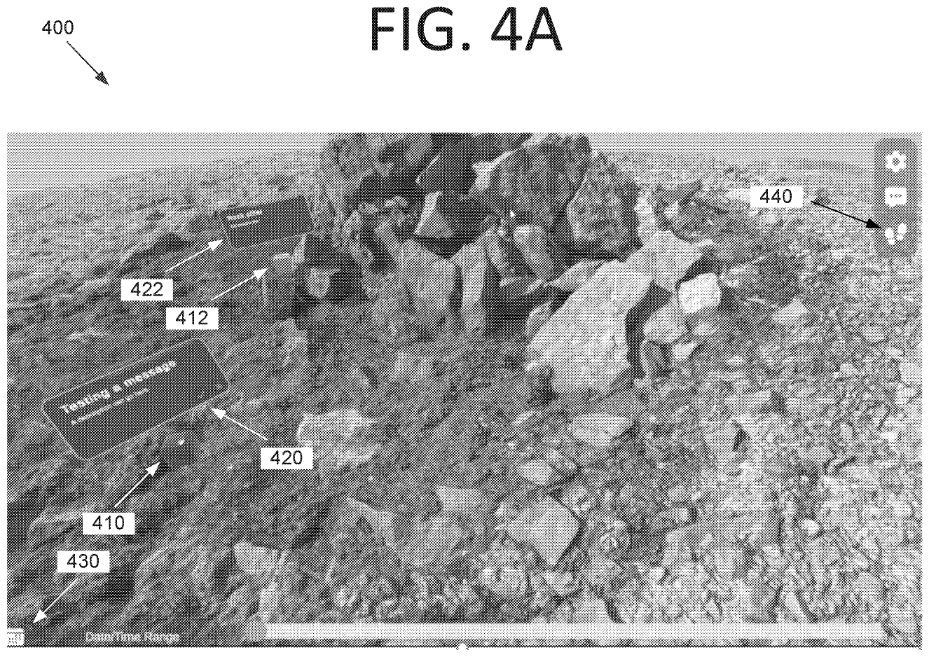

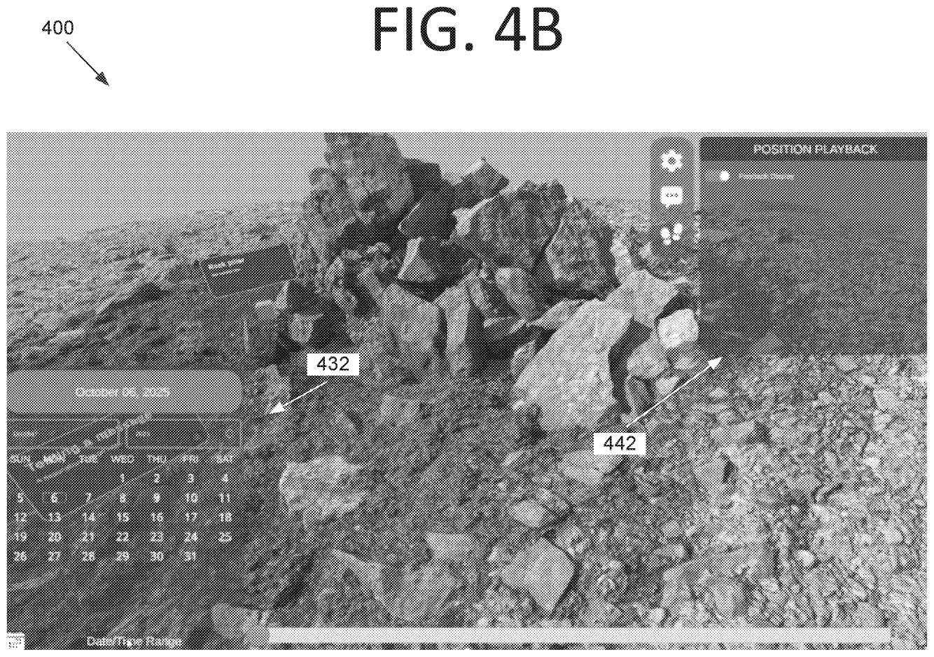

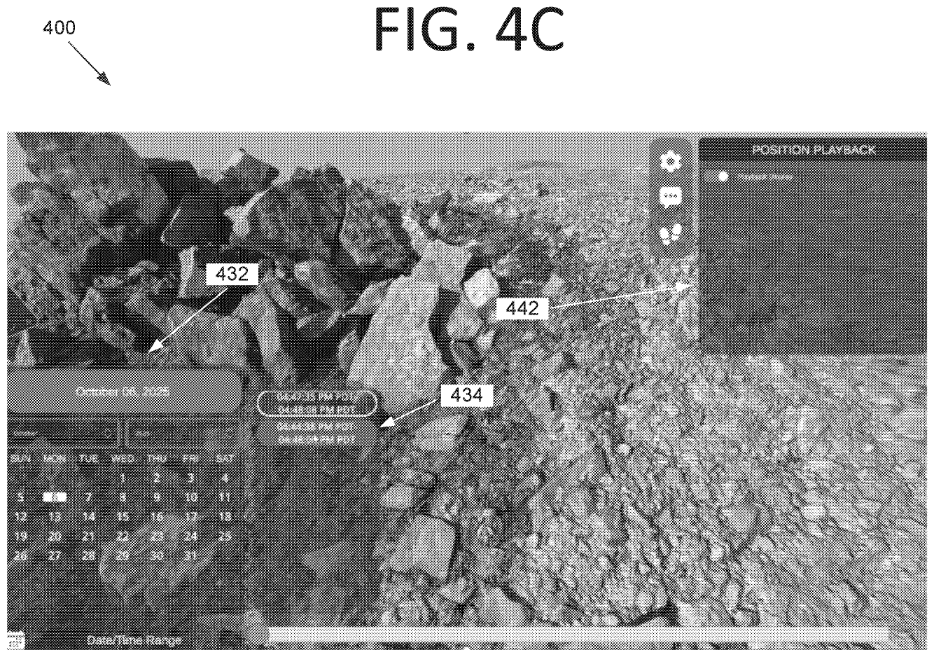

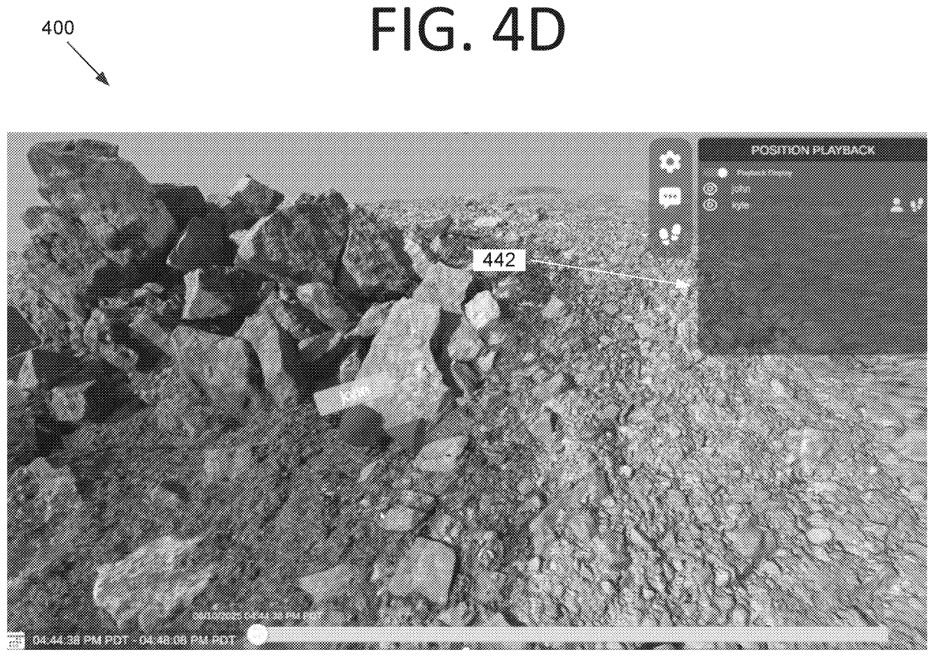

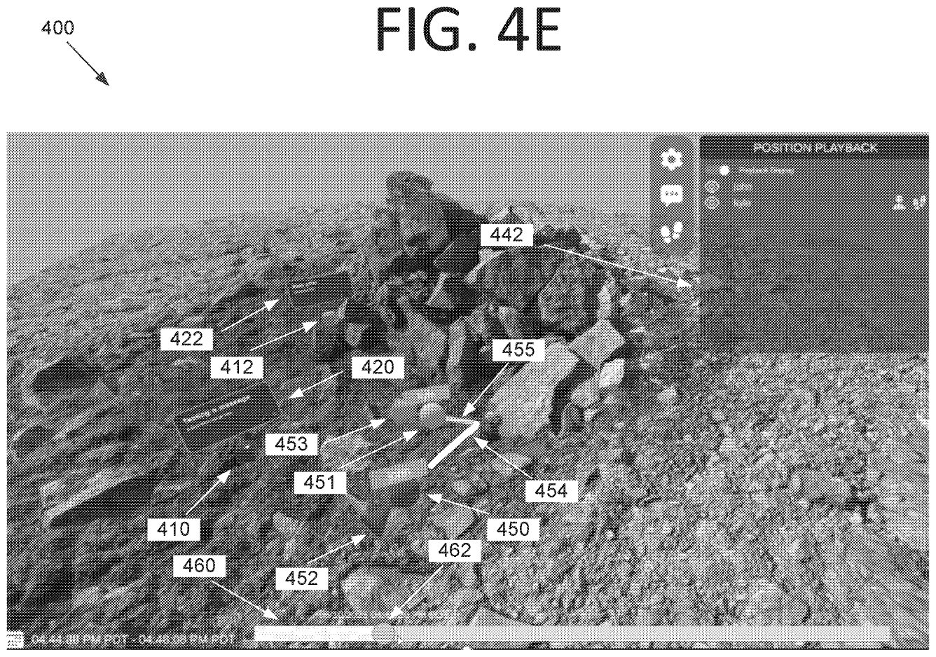

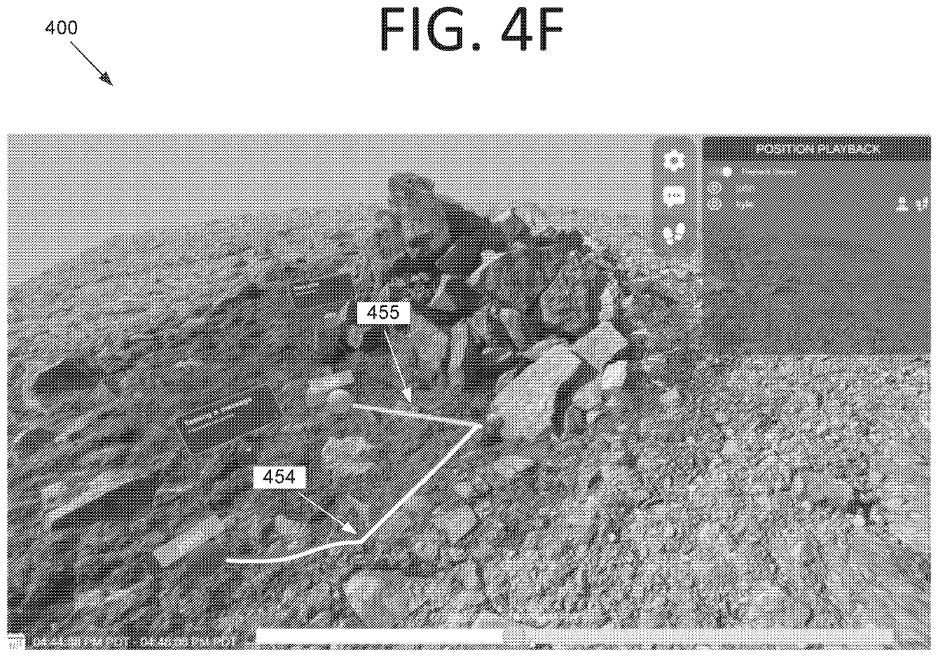

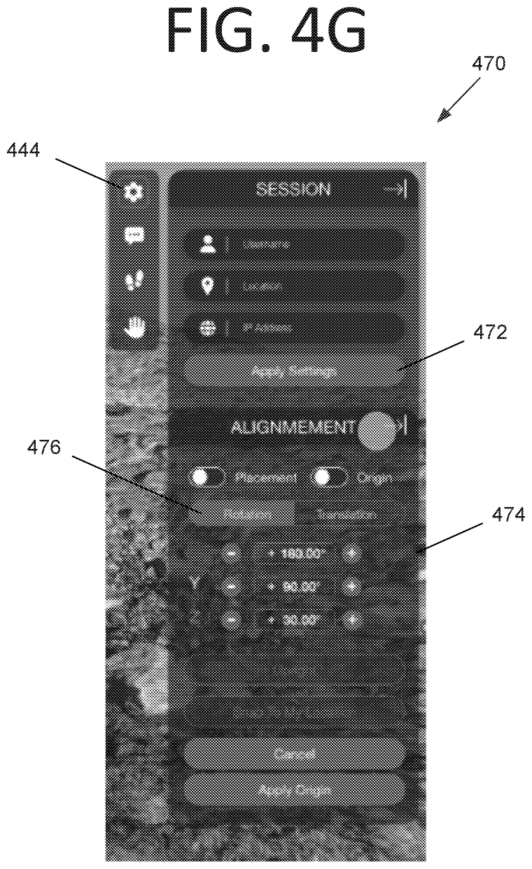

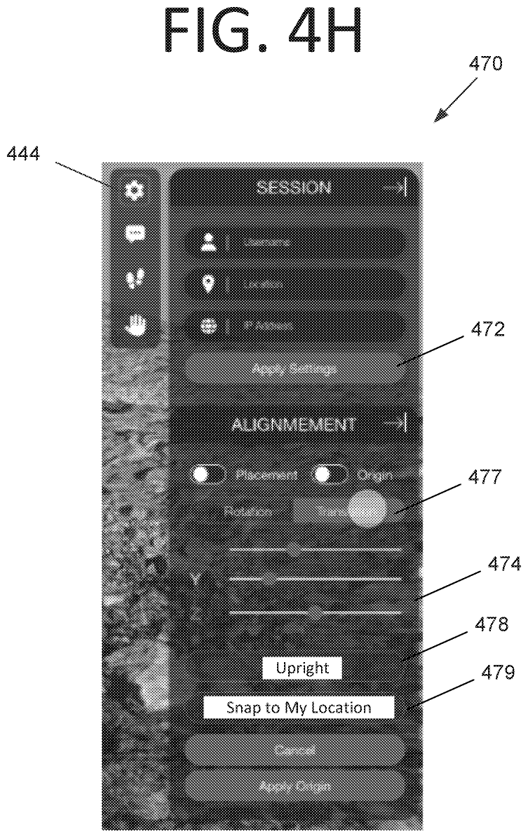

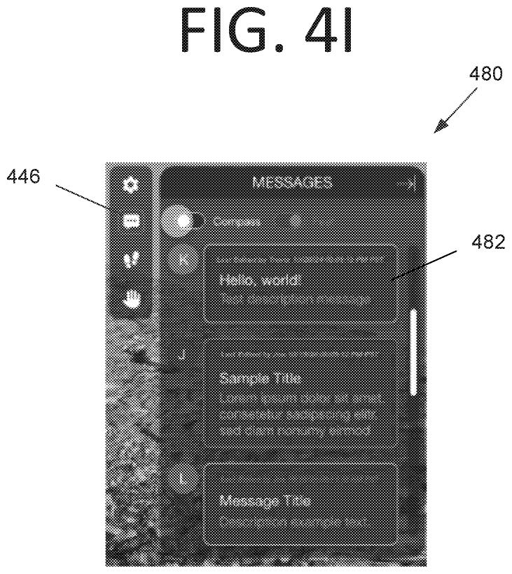

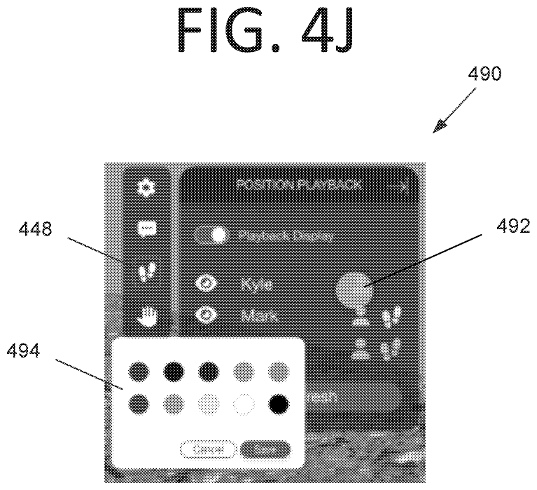

FIGS. 4A-J are computer-modeled images illustrating a remote interface 400 of a combined AR and remote system, according to an embodiment of the present invention. Remote interface 400 shows a view of a 3D digital twin of terrain in an area that the AR explorer either currently is in or was in. Turning to FIG. 4A, markers 410, 412 with respective messages 420, 422 are shown. The remote user can manipulate the view, zooming in and out and rotating the camera angle as he or she sees fit. A calendar icon 430 lets the user peruse dates to find recordings of explorations. A position playback icon 440 allows the remote user to enable position playback mode.

Turning to FIG. 4B, the remote user has clicked calendar icon 430 and position playback icon 440, bringing up calendar pane 432 and position playback pane 442, respectively. Turning to FIG. 4C, the remote user has selected the date Oct. 6, 2025, bringing up recordings pane 434 that shows the recordings that took place that day. The remote user selects a recording, and turning to FIG. 4D, explorers that are present in that recording are shown in position playback pane 442, as well as on the 3D digital twin of the area. The avatars showing the relative locations and head orientations of explorers John and Kyle also appear, but they overlap at the beginning in this figure.

Turning to FIG. 4E, a scroll slider 460 with a time control 462 allows the remote user to go forward and backward in time during the recording. The remote user can also continue to zoom in, zoom out, and rotate the view as desired using mouse controls, for example. Explorers John and Kyle are represented by current location circles 450, 451 that have respective view direction cones 452, 453 that show where they are currently looking. Respective paths 454, 455 that John and Kyle have taken up to that point in the recording are also shown.

Turning to FIG. 4F, as time proceeds, paths 454, 455 grow. This is like watching the explorers leave a holographic trail of footprints leading from their avatar. The start trail of the hologram path is representative of the start time of the timeline and the location of the avatar is wherever scroll slider 460 is on the timeline at the bottom. There are two slide bars in some embodiments-one for the start point and one for the end point. However, in this version, the default starting place is the far left of scroll bar 460 (i.e., the start of the recorded data selected in recordings pane 434).

Turning to FIG. 4G, when the remote user clicks a session configuration icon 444, a session pane 470 appears. Clicking apply settings button 472 thereof brings up alignment options 474. Rotation toggle 476 is selected by default in this embodiment and brings up rotation controls of alignment options 474.

Turning to FIG. 4H, when the remote user clicks translation toggle 477, translation controls of alignment options 474 appear. This is one of the ways to set up the virtual world and real world alignment. In this embodiment, it is not automatically recognized where the explorer is relative to the 3D digital twin without having an anchor point set up. However, in certain embodiments, this is not the case. For instance, in some embodiments, two or more Wi-Fi routers are used to detect/determine the location of individuals even through walls to align the real and virtual worlds. If it is known where the Wi-Fi routers are in a room, their locations can be coordinated with the 3D digital twin and then the location of persons can be displayed over the digital twin or an AR device can be associated with the detected human from the Wi-Fi system, and the real world and virtual world can be synced and the explorers with the 3D digital twin using this approach.

The top half of session pane 470 is used to set up the connection between the explorers and the session. If there were multiple remote users using the computer application to talk to the explorers, their names may be reflective of their usernames. Also, the location and Internet Protocol (IP) address help connect the explorers and remote users to the same project. The IP address here works as long as both the explorers and remote users are connected to the same Internet. Multiple projects pertaining to the same space may also be created. In some embodiments, websites or something else could be used such that the IP address is not required.

The alignment is where an x-y-z origin is set (FIG. 4H) and the orientation can be changed (FIG. 4G). The explorers should know where this is on the 3D digital twin so they can align it relative to that spot in the real world. Rotation enables fine adjustments rotating about x-y-z and translation translates across the x-y-z axis. Upright button 478 resets the y orientation to vertical (perpendicular) to the x-z plane (horizontal). This is from real world testing. Snap to my location button 479 moves the origin somewhere near the point of view of the explorer in case it somehow gets lost.

It should be noted that a printout of a digital marker that the application recognizes as being the origin may also be provided. This is useful for internal spaces, such as inside a room or a spaceship. Taping the printout to the corner of a table, etc. helps with automatic alignment of the real world and virtual world when the marker is in the field of view. Annotations can also be used as reference points instead of an x-y-z origin point as described above. These three mostly manual alignment techniques (i.e., alignment of the x-y-z origin point, the printout of a digital marker of the x-y-z origin, or alignment of an annotation as an alignment reference point) provide solutions to aligning the real world and virtual world. However, other solutions are possible without deviating from the scope of the invention (e.g., Wi-Fi router-based approaches).

Turning to FIG. 4I, then the remote user clicks message icon 446, a message pane 480 appears. A list of messages 482 from the explorers are visible. The message list includes metadata, such as the last time the message was edited and by whom. Turning to FIG. 4J, when the remote user clicks position playback options icon 448, a position playback pane 490 appears. Selecting an explorer icon 492 (in this case, Kyle) brings up a color palette 494 for that explorer. It should be noted that in this example, the remote user has selected a different date and recording, which has different explorers.

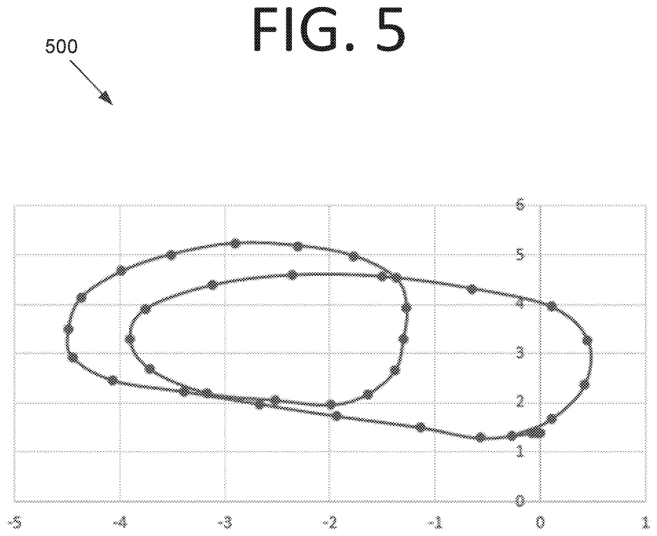

In some embodiments, the remote system portion may allow remote users to chart the path of an explorer. FIG. 5 is a graph 500 of an example. The graph was generated using the data from Table 1 below.

TABLE 1
GRAPH ORIENTATION COORDINATES FOR FIG. 5

| x Offset: | y Offset: | z Offset: | Date and Time: |
|---|---|---|---|
| −0.020672 | −0.384262 | 1.388278 | Jun. 25, 2025 |
| | | | 20:18:48.852Z |
| −0.005131 | −0.396309 | 1.392016 | Jun. 25, 2025 |
| | | | 20:18:49.880Z |
| −0.077646 | −0.404467 | 1.388258 | Jun. 25, 2025 |
| | | | 20:18:50.902Z |
| −0.572874 | −0.436498 | 1.288144 | Jun. 25, 2025 |
| | | | 20:18:51.925Z |
| −1.136124 | −0.455934 | 1.50286 | Jun. 25, 2025 |
| | | | 20:18:52.951Z |
| −1.941612 | −0.482814 | 1.736279 | Jun. 25, 2025 |
| | | | 20:18:53.977Z |
| −2.665165 | −0.565765 | 1.9754 | Jun. 25, 2025 |
| | | | 20:18:55.013Z |
| −3.394028 | −0.455662 | 2.230468 | Jun. 25, 2025 |
| | | | 20:18:56.023Z |
| −4.06035 | −0.418505 | 2.452058 | Jun. 25, 2025 |
| | | | 20:18:57.368Z |
| −4.450252 | −0.434885 | 2.926362 | Jun. 25, 2025 |
| | | | 20:18:58.171Z |
| −4.488502 | −0.480684 | 3.493056 | Jun. 25, 2025 |
| | | | 20:18:59.193Z |
| −4.36668 | −0.47754 | 4.139614 | Jun. 25, 2025 |
| | | | 20:19:00.323Z |
| −3.977965 | −0.513637 | 4.672601 | Jun. 25, 2025 |
| | | | 20:19:01.348Z |
| −3.507337 | −0.520568 | 5.013583 | Jun. 25, 2025 |
| | | | 20:19:02.371Z |
| −2.905881 | −0.508441 | 5.239555 | Jun. 25, 2025 |
| | | | 20:19:03.396Z |
| −2.306012 | −0.513739 | 5.186426 | Jun. 25, 2025 |
| | | | 20:19:04.419Z |
| −1.780752 | −0.52094 | 4.986053 | Jun. 25, 2025 |
| | | | 20:19:05.439Z |
| −1.373994 | −0.515358 | 4.528699 | Jun. 25, 2025 |
| | | | 20:19:06.285Z |
| −1.270769 | −0.49814 | 3.930211 | Jun. 25, 2025 |
| | | | 20:19:07.491Z |
| −1.30504 | −0.499378 | 3.284745 | Jun. 25, 2025 |
| | | | 20:19:08.515Z |
| −1.378725 | −0.470178 | 2.666927 | Jun. 25, 2025 |
| | | | 20:19:09.434Z |
| −1.643011 | −0.459813 | 2.179537 | Jun. 25, 2025 |
| | | | 20:19:10.461Z |
| −1.992383 | −0.44283 | 1.959352 | Jun. 25, 2025 |
| | | | 20:19:11.484Z |
| −2.515241 | −0.387553 | 2.057186 | Jun. 25, 2025 |
| | | | 20:19:12.513Z |
| −3.172503 | −0.391954 | 2.199198 | Jun. 25, 2025 |
| | | | 20:19:13.536Z |
| −3.717331 | −0.416823 | 2.69105 | Jun. 25, 2025 |
| | | | 20:19:14.556Z |
| −3.902184 | −0.424854 | 3.299662 | Jun. 25, 2025 |
| | | | 20:19:15.581Z |
| −3.754114 | −0.459079 | 3.910487 | Jun. 25, 2025 |
| | | | 20:19:16.605Z |
| −3.117251 | −0.515039 | 4.391744 | Jun. 25, 2025 |
| | | | 20:19:17.636Z |
| −2.360358 | −0.509787 | 4.592715 | Jun. 25, 2025 |
| | | | 20:19:18.752Z |
| −1.508733 | −0.520344 | 4.563863 | Jun. 25, 2025 |
| | | | 20:19:19.777Z |
| −0.654187 | −0.539478 | 4.320785 | Jun. 25, 2025 |
| | | | 20:19:20.805Z |
| 0.104906 | −0.507565 | 3.949087 | Jun. 25, 2025 |
| | | | 20:19:21.835Z |
| 0.4524 | −0.476674 | 3.261917 | Jun. 25, 2025 |
| | | | 20:19:22.853Z |
| 0.421497 | −0.445675 | 2.366089 | Jun. 25, 2025 |
| | | | 20:19:23.877Z |
| 0.105972 | −0.437002 | 1.675688 | Jun. 25, 2025 |
| | | | 20:19:24.900Z |
| −0.269996 | −0.396708 | 1.336045 | Jun. 25, 2025 |
| | | | 20:19:25.923Z |

Other information, such as the source (e.g., phone, tablet, AR headset, etc.), x-y-z orientation over time, and the like may also be tracked. It should be noted that graph 500 of FIG. 5 is only one way that the data can be used. Here, the x and z columns were plotted, which resulted in a top-down map showing the path that the explorer took. A top-down view of the 3D digital twin could also be imposed on top of this and made transparent to see where this explorer was. Heat maps could also be generated. It should be noted as well that the coordinate system is arbitrary here and any desired coordinate system may be used without deviating from the scope of the invention.

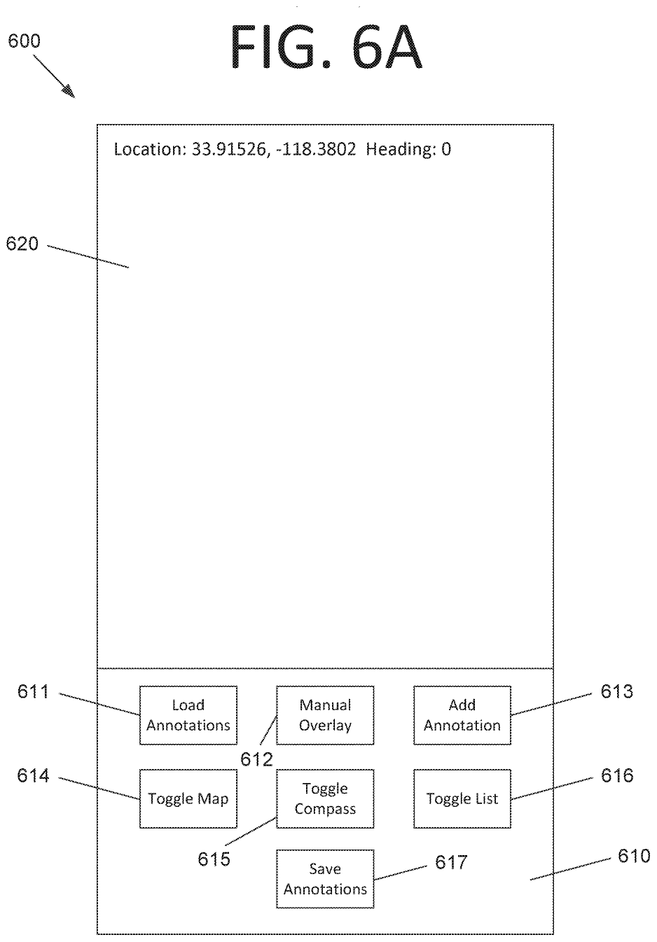

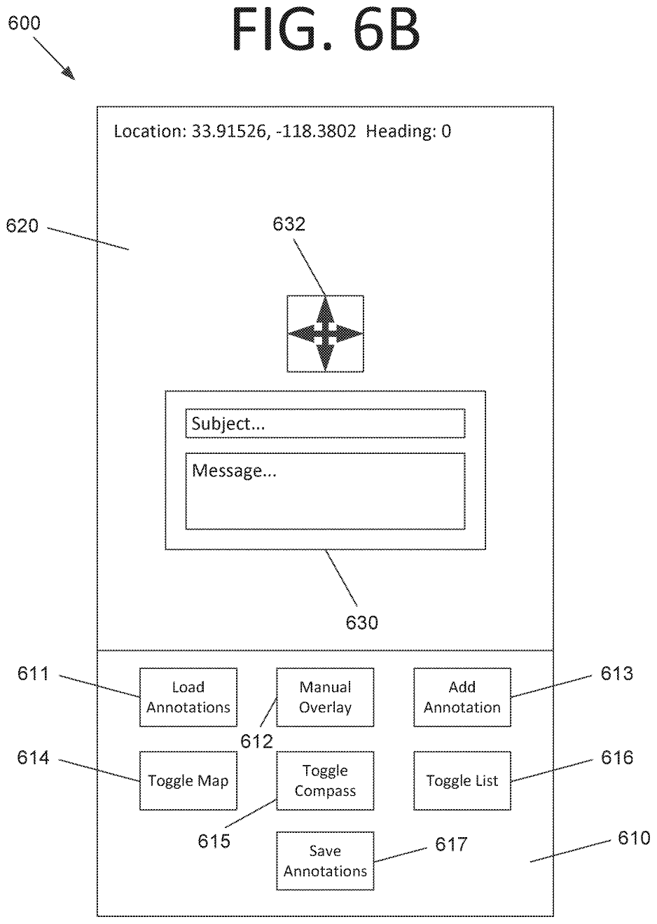

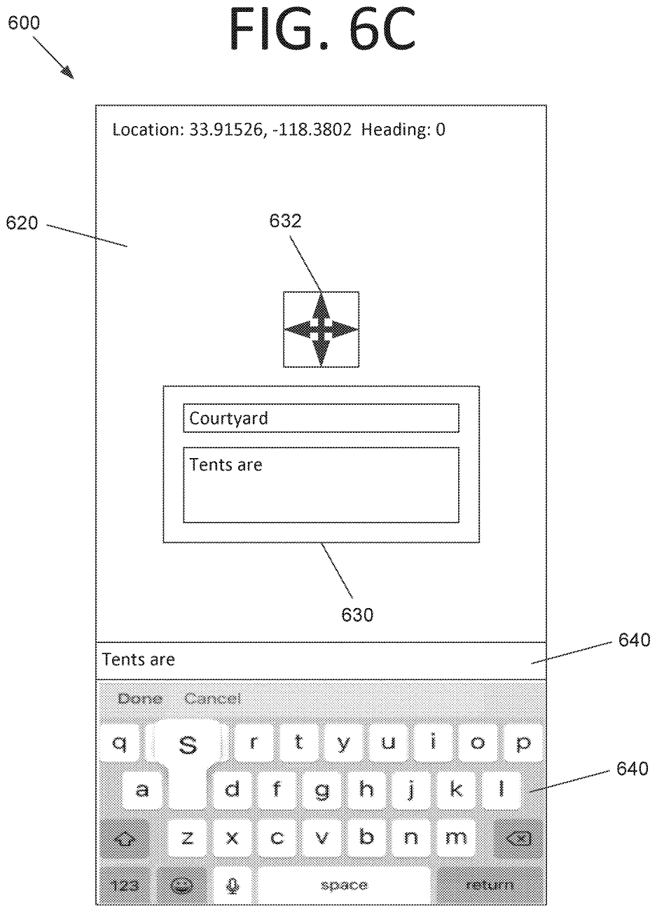

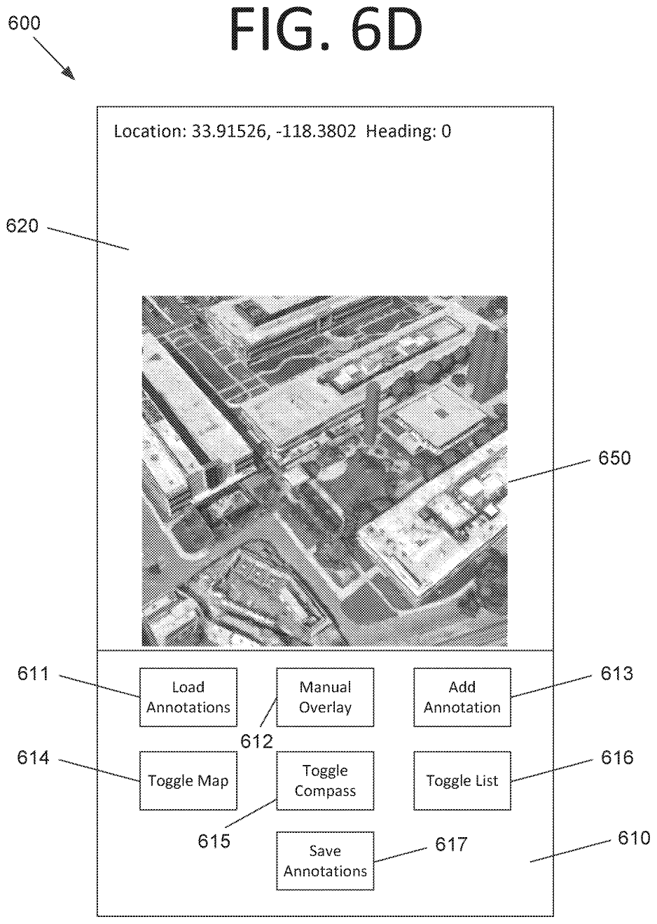

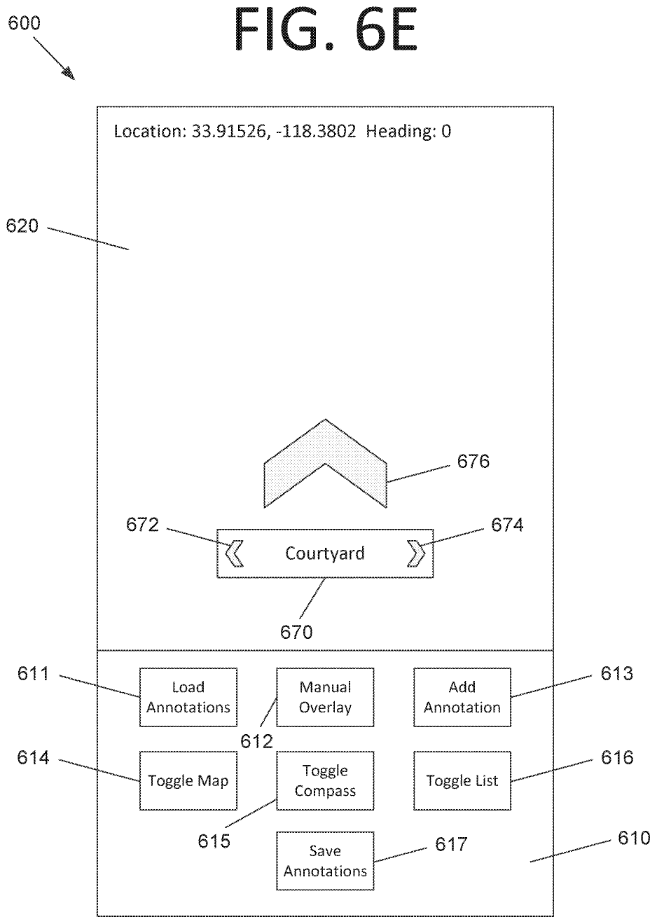

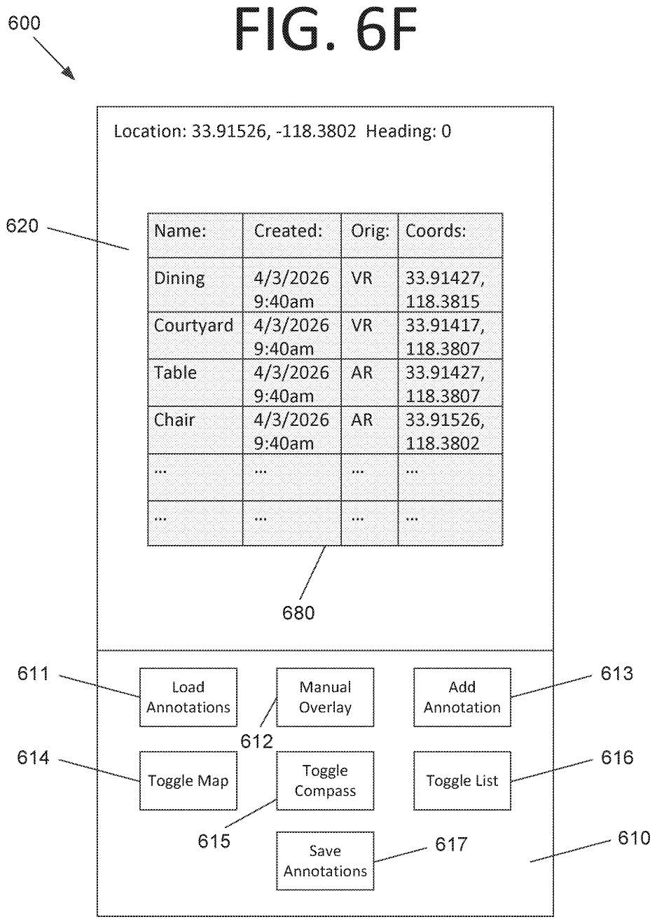

It should be noted that embodiments are not limited to extraterrestrial exploration. FIGS. 6A-F illustrate a user interface 600 of an AR smart phone application that allows an AR explorer to place and edit annotated holograms and share them with remote users as well, according to an embodiment of the present invention. A menu pane 610 includes a load annotations button 611 that loads existing annotations in the AR explorer's area, a manual overlay button 612 that is for aligning the real world and the virtual world, an add annotation button 613 that allows the AR explorer to add new annotations to the environment, a toggle map button 614 that brings up a map of the area, a toggle compass button 615 that overlays a compass over the screen, a toggle list button 616 that brings up a list of local locations and directions thereto, and a save annotations button 617 that saves the newly created annotations and/or annotation modifications to the cloud, for example, so other AR explorers and remote users can see them. A camera screen 620 shows the current view from the camera(s) of the phone. The explorer may touch camera screen 620 and move annotations around wherever he or she wants to place them.

When the AR explorer presses add annotation button 613, turning to FIG. 6B, an annotation 630 and location control 632 appear. When the AR explorer clicks the subject or message body of annotation 630, turning to FIG. 6C, a keyboard appears. Typed text appears in a text area 640, as well as in the subject or message body of annotation 630.

When the AR explorer clicks toggle map button 614, turning to FIG. 6D, a map 650 of the area appears. The AR explorer can rotate the map, zoom in, and zoom out. The AR explorer can also move the location of the map on camera screen 620. The map also has color coded pins in this embodiment showing where annotations are and a box representing where the explorer is. This feature makes it easier to find annotations.

When the AR explorer clicks toggle compass button 615, turning to FIG. 6E, Actually the title of an annotation in the environment appears and the AR explorer can toggle between different annotation titles, such as scrolling through a list and the compass then pointing to whichever annotation is closest (e.g., for a building, a monument, an object, etc.) appears in location label 670 in the direction of direction arrow 676. Arrows 672, 674 cycle between annotation titles, and arrow 676 then points to that annotation. When the user clicks direction arrow 676, it rotates 90° and location label 670 updates to indicate the nearest item of interest in that direction. Direction arrow 676 also moves as the AR explorer moves to keep pointing towards that item of interest. When the AR explorer clicks toggle list button 616, turning to FIG. 6F, a list of nearby holograms 680 appears (in this case, a list of annotations) that includes the location name, the date the annotation was created, whether it originated from AR or VR, and the coordinates thereof.

With respect to the remote aspect of the combined AR and remote system, this virtual environment can then be experienced by remote users in either an application on a computing system (e.g., a desktop computer, laptop computer, smart phone, tablet, etc.) or a VR interface (e.g., a headset, a mobile phone, a tablet, etc.). The users can create various annotations, such as voice recordings, images, text, etc., and place these annotations in the virtual 3D model of the real world. It should be noted that some embodiments exchange saved files between remote and AR users, but in some embodiments, updates are exchanged over the network in near-real time.

Annotations and other holograms are linked to the physical world via a coordinate system in some embodiments, such as GPS coordinates. However, per the above, in some embodiments, GNSS coordinates are not used. These annotations may ultimately be converted into a left handed coordinate system such as the Unity™ coordinate system, a right handed coordinate system such as the Blender™ coordinate system, or any other non-GNSS coordinate system without deviating from the scope of the invention, to display the annotations to the user, but this position is not necessarily stored in the database since it will change depending on where the AR application is launched from or where the “reference anchor point” is. The geocoordinates, however, typically stay consistent.

It should be noted that for embodiments that do not use GNSS, if the location of the real world version of the 3D digital twin is known, this location can be extrapolated to where the explorer is in the real world, and GNSS coordinates can be shown without having to actually access GNSS. Since GNSS is not as accurate or available in space or on other extraterrestrial bodies, it is generally not used in such instances. However, GNSS is used in some embodiments in a procedure that calibrates the real world and the virtual world. For instance, the AR explorer could use GNSS until close to a location, and then another alignment strategy such as those discussed above to get even closer to correct virtual world and real world alignment.

The virtual world and the real world can be aligned using a synthetic square marker (e.g., an ArUco marker) anchor point in some embodiments. Alternatively, the virtual world and the real world can be manually aligned. GNSS alignment may be preferred in some embodiments, however.

New 3D models of the real world can be spliced together to increase the fidelity of the virtual world model. The annotations or other holograms created by users in the virtual world can be replied to by explorers in the real world in some embodiments. New annotations or other holograms can be made by explorers in the real world for users to see in the virtual world. Thus, both AR and remote users may work collaboratively. In some embodiments, a 3D digital twin can act like a 3D sandbox for holograms to navigate. This may look like holograms are navigating the real world. For instance, the hologram may avoid phasing through walls, but navigate door frames or walk up hills and the like because the 3D digital twin is being used as a reference.

Annotations can also be interacted with in multiple ways in some embodiments. Explorers may leave text memos, voice recordings, or videos on annotations. This creates a back-and-forth form of communication between users interacting with the remote world and explorers in the AR world. These features flow in a feedback loop in some embodiments. As the explorers generate more data from the physical world, the data is processed. The virtual users can analyze and annotate the data, and then flow the annotated data back out to the explorers.

It should be noted that a 3D model is not needed to get started in some embodiments. An AR explorer can place annotations or other holograms in the real world, collect data to make 3D digital twins thereof, and then subsequently combine the two. There are limitations on what a remote observer is going to be able to do if there is not already a 3D model since it is typically the first contact with the site. However, when annotations are combined with the 3D model that was made after first contact, each contact with the site thereafter can leverage the 3D model for back-and-forth communication. This is somewhat akin to if the AR explorer wrote an email and the remote users would respond to it later instead of in real time. In other words, AR explorer first contact and second contact are accommodated, not just the second contact with the site. However, until the 3D model is made, the remote users would not have a reference to understand what explorers are putting annotations/holograms on or walking around.

In addition to labels, AR and remote users can attach voice recordings and/or videos to holograms in some embodiments. When placed in the remote model, these appear in the appropriate location in the AR model as well. For instance, a remote scientist may leave an annotation for an astronaut to explore a desired feature on the moon, Mars, etc. AR explorers may also modify and/or provide text for annotations using an AR keyboard in some embodiments.

The AR user interface (UI) may have various tools and options for use in the real world, such as those shown and described in FIGS. 6A-F. For instance, a map may be toggled on and off (explorer view 3D map). In some embodiments, the map provides an aerial view with the AR explorer's location and the locations of features and associated annotations. In certain embodiments, the AR explorer may be able to grab the map with two fingers, move the map around, and manipulate the map. In some embodiments, the annotations created by remote users appear as pins on the 3D map floating in front of the user.

The pins may be color coded to indicate certain statuses. For instance, a pin and/or annotation for a location, feature, or object that an AR explorer has not visited yet may appear in one color, and then change color when the AR explorer visits that location. The annotation may also change color when a message has been added by an AR explorer, a remote user, or both. The changes may appear in both the AR and remote models.

In some embodiments, the annotations and/or pins appear as holograms having sizes that correspond to the distances from the AR explorer. In other words, the holograms may be smaller when they are further away and increase in size as the AR explorer approaches them, i.e., objects are large the closer they are to the AR explorer. Since distant holograms may be difficult to see, some embodiments include a compass that can be toggled by the AR explorer and allows the AR explorer to toggle to an annotation that the explorer wants to view and navigate to the location of the annotation (e.g., by being guided by a 3D arrow that appears in front of the explorer). In certain embodiments, multiple annotations may be strung together as waypoints that guide the explorer to the next annotation and allow locations associate with the annotations to be visited in order.

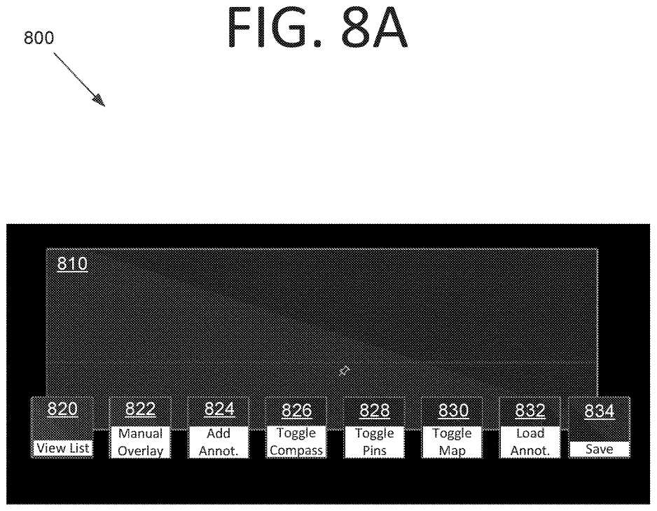

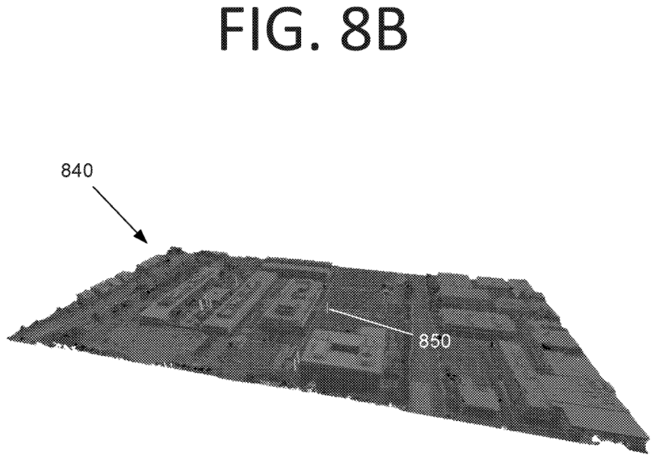

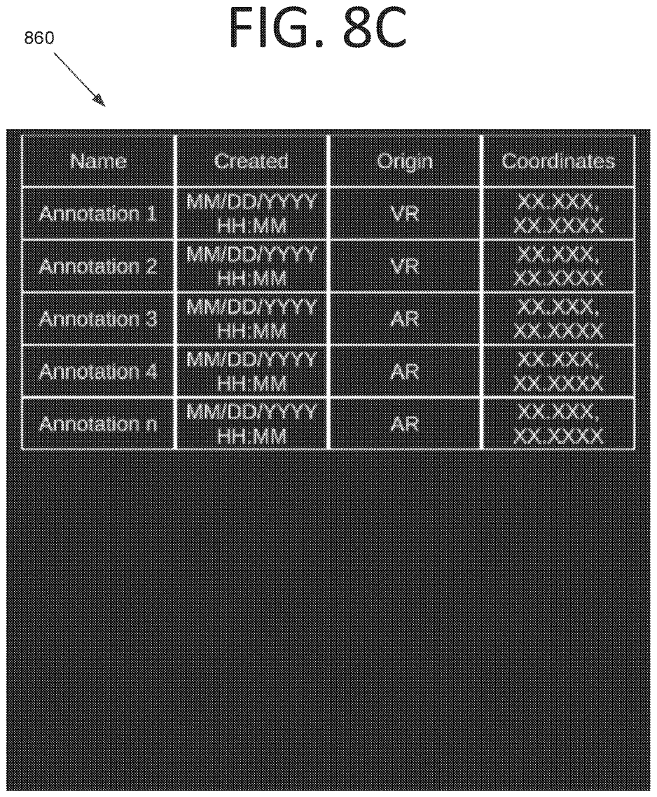

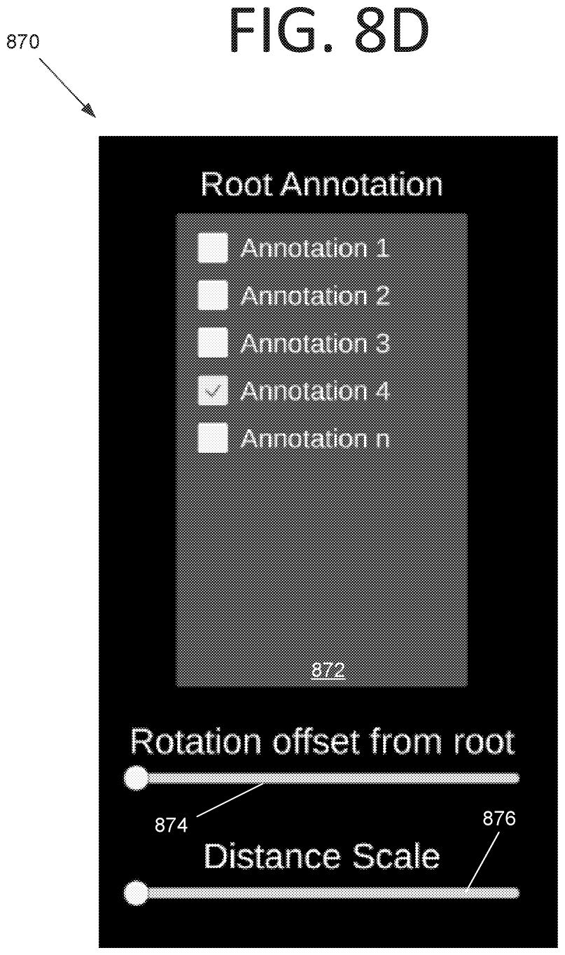

In some embodiments, a menu may be provided in the UI that allows the AR explorer to view the annotations in the environment. The menu may include searchable annotation names, the maker (e.g., AR explorer or remote user) of the annotation, the coordinates of the annotation, when the annotation was made, the current distance to the annotation, the relative location of the annotation, etc. This may allow AR explorers to search annotations that are available in the model choose and/or prioritize which annotations to visit. See FIG. 8D, for example.

The real, AR world and the virtual world should be aligned to ensure that locations for annotations in the models for remote users and AR explorers match. In some embodiments, synthetic square markers such as ArUco markers may be used as anchor points. These are binary square markers that are somewhat like quick response (QR) codes. Since the location of the marker in the virtual world is known, if an AR explorer sees that marker in the real world, the explorer knows the location in the real world versus the virtual world. In other words, the marker aligns annotations around the AR explorer to ensure that the annotations appear in the appropriate location in both the AR and remote models. This may be useful for a museum plaque or another object of interest, for example. An ArUco marker or other synthetic square marker for such a physical object could serve as an anchor for both the virtual world and the real world.

In some embodiments, manual alignment may be used. If the location of where an annotation should be in the real world is known and you want the annotation to be positioned accurately relative to the virtual world, the AR explorer may toggle a manual alignment button and physically select where the annotation should be in the real world. The AR explorer can position the annotation relative to him or herself and in some embodiments, pivot the relative positions of the remaining annotations using a slide bar, for example. Once the position of a single annotation is set, the slide bar may be used to rotate the remaining annotations around the set annotation so all annotations are placed correctly relative to the set (root) annotation. If the scale is off between the virtual world and the real world, the AR explorer can change the location of proximate annotations (or in some embodiments, all annotations in the model) by zooming in or out and/or rotating the annotations.

For example, consider the case where a remote user would like to place an annotation on a plaque in a monument or a museum. The alignment in the real world may not be accurate. An AR explorer may visit the plaque, choose the manual alignment option, move the annotation over the plaque, and use the slide bar to rotate all other annotations until they line up. Then, the AR explorer may scale the annotations around the plaque until they are separated from one another by the correct distances. In other words, this ensures that the annotations in the area are in the correct positions relative to one another.

To track where AR explorers actually are, a coordinate system may be used relative to the virtual world. This may be performed by taking an initial reference point and its GPS coordinates, and then using an AR explorer's relative position from this point to determine the current GPS coordinates of the AR explorer. This method may be used for both displaying an AR explorer's current position on a 3D map and for placing annotations in the AR environment. The AR explorer's real world position can then also be sent to remote users in the virtual world to see the AR explorer's position as it updates, potentially in real time.

In some embodiments, GPS or another GNSS may not be required to continue to map the AR explorer's location to the virtual world. The AR user may ping his or her location once to get a reference. After that, sensors in the AR headset, such as a magnetometer, accelerometer/inertial measurement unit (IMU), gyroscope, processing of images of visual input that the user is moving past etc., may be used to update the AR explorer's position in the remote model.

In some embodiments, 3D models may be used as part of or in lieu of annotations. For instance, 3D models of objects (e.g., a car, a plane, a character, etc.) may be placed in the real world as holograms for AR explorers. The programs (e.g., code sets for the holograms paired with the AR models themselves) may be stored in a database. In certain embodiments, the 3D models may have animations and/or may move around to different locations. Geofencing may be provided for the 3D models to constrain 3D models to respective areas, ensure that they do not run through real world objects, ensure that they are obscured if behind real world objects, etc. In some embodiments, the holograms may have associated audio that gets louder or quieter as the AR explorer moves toward or away from the hologram, respectively. In some embodiments, holograms may have non-fungible tokens (NFTs) where holograms are build on the blockchain, one individual owns the hologram, and the hologram is the only one appearing at a certain location and within a certain proximity thereto.

In some embodiments, an application window may appear for both AR explorers and remote users, where the application window is tied to GPS coordinates or some other coordinate system. For instance, for a videoconferencing application, a hologram of a window with video panes for respective users in AR and/or VR (or other remote software) may appear to respective AR explorers. Remote users would also be able to view an interface for the application on their computing systems.

In some embodiments, holograms may have AI and may solve problems. For instance, holograms could be provided with real world objectives and use AI/ML model(s) to accomplish the objectives. AI holograms may attempt to navigate the real world to find paths to locations, operate as a swarm to accomplish group objectives, etc.

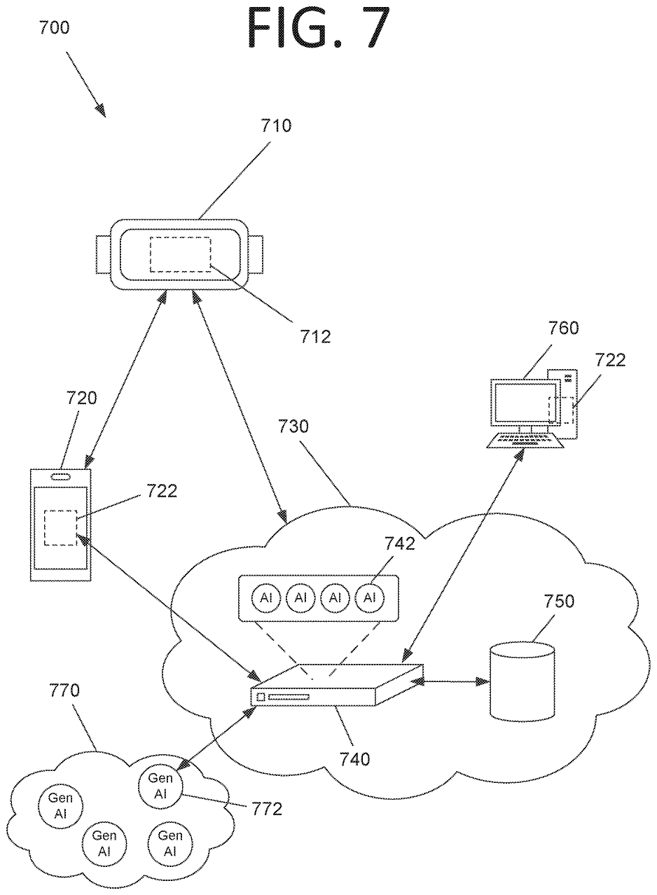

FIG. 7 is an architectural diagram illustrating a system 700 configured to provide combined AR and VR with a feedback loop, according to an embodiment of the present invention. An AR headset 710 includes an AR application 712 that provides an AR interface for an explorer in the real world. AR application 712 includes or has access to 3D models of the real world that may provide annotations, holograms, and the like that correspond to locations proximate to the AR explorer in the real world. AR application 712 may allow AR explorers to add or modify annotations, provide a 3D map and a menu that allows AR explorers to find and navigate to annotations and/or other holograms, leave text memos, create voice recordings, and/or create videos on annotations, provide the AR explorer's current location, align the locations of annotations in the AR world with the VR world, provide images to improve the fidelity of the VR models, interact with holograms (e.g., via a camera of AR headset 710), etc. Sensors of AR headset may be used by AR application 712 to provide location changes so VR users can see the updated location of the AR explorer as the AR explorer moves around an environment.

In some embodiments, AR explorers may use a smart phone 720 to capture high resolution images of the environment so the fidelity of the VR model can be improved and/or the images can be incorporated into annotations. Smart phone 720 may also run a VR application 722 so the AR explorer can see what the VR users see. Alternatively, VR application 722 may be run on headset 110, and the AR explorer may toggle between AR application 712 and VR application 722.

AR application 712 and VR application 722 send communications to and receive communications from a server 740 via a network 730 (e.g., a local area network (LAN), a mobile communications network, a satellite communications network, the Internet, any combination thereof, etc.). In some embodiments, server 740 is part of a public cloud architecture, a private cloud architecture, a hybrid cloud architecture, etc. In certain embodiments, server 740 may host multiple software-based servers on a single computing system. In certain embodiments, multiple servers are used.

Cloud server 740 includes AI/ML models 742 that have been trained to perform certain functions. For example, a computer vision (CV) model may be used to process video images sent from AR application 712 to server 740 and identify objects therein. These objects may then be labeled with holograms in AR application 712. As discussed above, one or more of AI/ML models 742 may be models for holograms shown by AR application 712. These holograms may move, solve problems, generate chat text or speech, etc. based on output from such models. The models, annotations, VR and AR world models, etc. may be stored in a database 750.

The models may have animations associated with them in some embodiments. Along with these animations, the models may also have behaviors defined for them, such as path finding algorithms. These names of the associated path finding behaviors may be stored with the models, while the logic for executing the behaviors may reside in the AR or VR application itself. After a model and behavior is selected from the database, a user can select a destination for a model in their environment, or specify that the model roams within a certain boundary. The combination of these models, path finding behaviors, and objectives encompass a simulation that can be run in AR or VR.

Consider the example of pathfinding through terrain for an AR explorer. Objectives may be stored in the code for the hologram. The AR explorer may download hologram files and have pre-saved commands. If the hologram can run, jump up and down, hover, etc., the commands may instruct the hologram to navigate to a point using the shortest distance, run faster, jump higher, etc.

In some embodiments, the AR explorer may specify how he or she wants the hologram model to move around in the world. For instance, the AR explorer may specify that the hologram is able to interact with other models, that it ignores other models, that it tries to avoid walls, stays in the ground, performs collision detection for itself versus objects in the environment and other models, etc. In some embodiments, cameras may be used to create 3D avatars of people. These 3D avatars could then be used along with dialogue from that person analyzed by a generative AI model to create an AI version of that person that would speak similarly. If included in the AR environment as a hologram, this AI person could accompany the AR explorer as he or she moves around. This could also be done for a pet, a movie character, etc.

Computing system(s) 760 for VR user(s) run VR application 722, which also communicates with server(s) 140. VR application 722 runs models of the virtual world. VR application 722 also displays and updates locations of AR explorers, allows VR users to create/change annotations, aligns locations provided by AR application 712 in the virtual world, etc.

In some embodiments, generative AI models are used. Generative AI can generate various types of content, such as text, imagery, audio, and synthetic data. various types of generative AI models may be used, including, but not limited to, large language models (LLMs), generative adversarial networks (GANs), variational autoencoders (VAEs), transformers, etc. These models may be part of AI/ML models 742 hosted on server 740. For instance, the generative AI models may be trained on a large corpus of textual information to perform semantic understanding, to understand the nature of what is present on a screen from text, and the like. In certain embodiments, generative AI models 772 provided by an existing cloud ML service provider 770, such as OpenAI®, Google®, Amazon®, Microsoft®, IBM®, Nvidia®, Facebook®, etc., may be employed and trained to provide such functionality. In generative AI embodiments where generative AI model(s) 772 are remotely hosted, server 740 can be configured to integrate with third-party APIs, which allow server 740 to send a request to generative AI model(s) 772 including the requisite input information and receive a response in return. Such embodiments may provide a more advanced and sophisticated user experience, as well as provide access to state-of-the-art natural language processing (NLP) and other ML capabilities that these companies offer.

FIG. 8A is a screenshot illustrating an AR explorer interface 800, according to an embodiment of the present invention. The AR explorers interact with the menu interface in some embodiments by pressing buttons with their fingers or through voice commands. An annotation 810 is also shown. A view list button 820 displays a list of each annotation in the current session, along with the annotation coordinates, date of creation, and where the annotation originated from (AR or VR user). See FIG. 8C. An enable manual overlay button 822 allows the user to manually set the positions of annotations. An add annotation button 824 creates an annotation that the AR explorer can write a title and description for via a virtual keyboard or through voice memos. A toggle compass button 826 displays a marker that points to an indicated annotation to guide a user to the selected annotation. A toggle pins button 828 either displays or hides pins on the virtual AR map indicating the location of annotations and the AR explorer's current position on the map. A toggle map button 830 hides or displays the AR map. A load annotations button 832 allows a user to select a data file containing a list of annotations to be displayed. A save button 834 allows a user to save the current session to a data file locally on the headset.

FIG. 8B illustrates an AR explorer map 840 that may be superimposed over the real world, according to an embodiment of the present invention. AR explorer map 840 includes pins 850 that indicate the location of annotations. In some embodiments, pins 850 may indicate the locations of AI/ML-driven holograms that the AR explorer can visit and interact with.

FIG. 8C is a screenshot illustrating a view list interface 860 that displays a list of annotations in the current session, according to an embodiment of the present invention. In this embodiment, the AR explorer is able to see the annotation name, the date that it was created, whether it was created by an AR explorer or a VR user, and the coordinates of the annotation. FIG. 8D is a screenshot illustrating a root annotation rotation and scaling interface 870 where the AR explorer can change the location of proximate annotations zooming in or out and/or rotating the annotations based on a root annotation, according to an embodiment of the present invention. An annotation selection pane 872 allows the AR explorer to select the root annotation from a list of annotations. A rotation offset from root slider 874 lets the AR explorer rotate the other annotations around the root annotation. A distance scale slider 876 allows the AR explorer to change the scale of the other annotations relative to the root annotation.

In other words, FIG. 8D shows one of various ways for aligning the real world and the virtual world. The root annotation serves as the anchor point for the real world and the virtual world. The explorer can then rotate the annotations in the virtual world about this root annotation. The scale of the distance that the other annotations are from one another can be adjusted. The idea is that the explorer is trying to align the annotations in the real world where he or she already knows they are located in the virtual world.

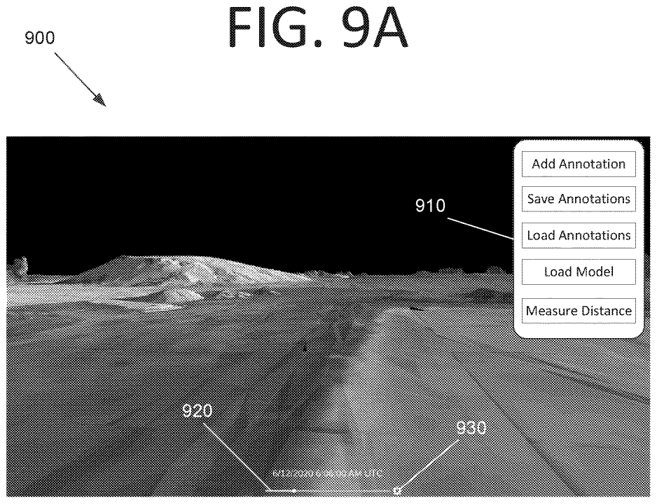

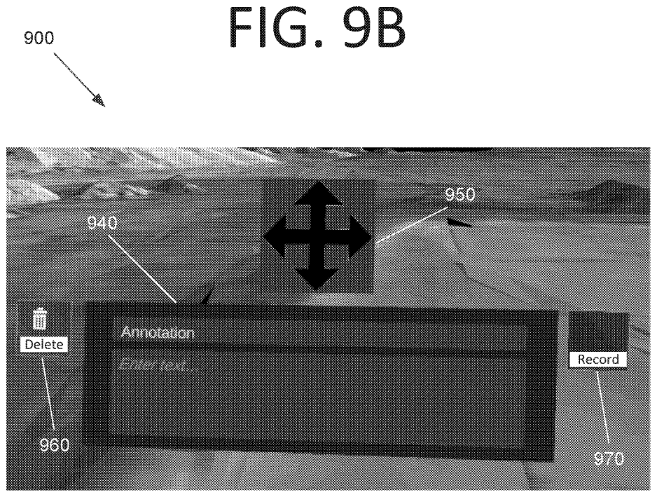

FIG. 9A is a screenshot illustrating a VR user interface 900, according to an embodiment of the present invention. VR user interface 900 includes some or all of the same buttons as the AR explorer interface in menu 910 in some embodiments (e.g., AR explorer interfaces 600 or 800 of FIGS. 6A-F and 8A-D, respectively). In this embodiment, VR user interface 900, via menu 910, also allows the user to load a 3D model, and optionally GPS coordinates of this model, to automatically place the 3D model on top of the VR map at its geocoordinates. The user can then manually move this object to further align the model with the map. Measure distance is used to measure the actual distance between two points on the VR map. The VR user can also change the date and time of the simulation to view different lighting effects on the environment at different times in some embodiments. Slider 920 allows the VR user to change the time of day over a 24 hour period. Gear icon 930 allows the VR user to change the date.

FIG. 9B illustrates a portion of VR user interface 900 of FIG. 9A with an annotation 940, according to an embodiment of the present invention. Annotation 940 allows the VR user to add a title and an associated description. Navigation button 950 allows the VR user to move the location of annotation 940 on the map. Delete button 960 allows the VR user to delete the annotation and record button 970 allows the VR user to record an audio recording for the annotation.

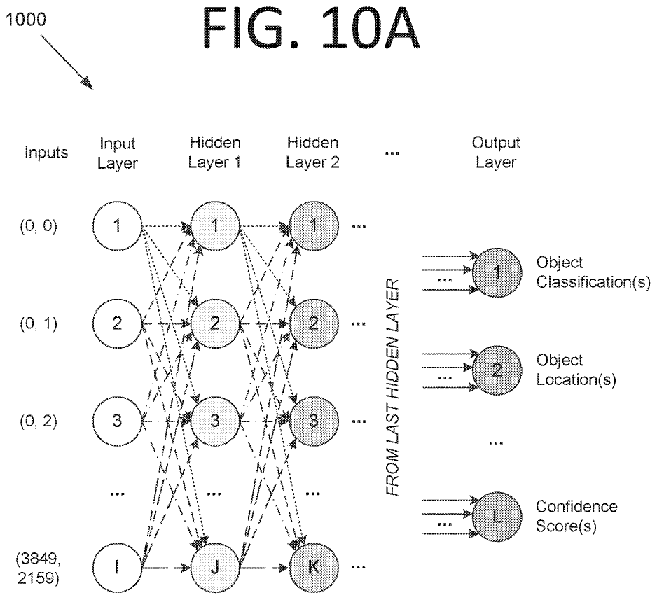

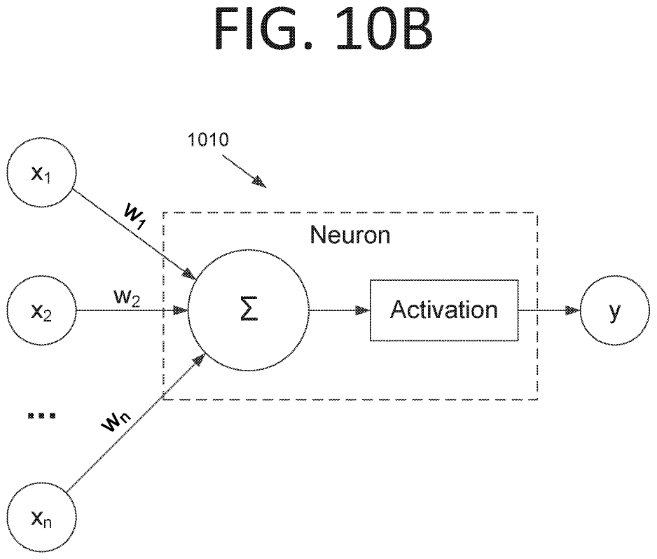

Per the above, AI/ML may be used by AR applications in some embodiments. Various types of AI/ML models may be trained and deployed without deviating from the scope of the invention. For instance, FIG. 10A illustrates an example of a neural network 1000 that has been trained to recognize graphical elements in an image to augment AR or VR, according to an embodiment of the present invention. Here, neural network 1000 receives pixels of a screenshot image of a 3820×2160 image as input for input “neurons” 1 to I of the input layer. In this case, I is 8,251,200, which is the total number of pixels in the image (e.g., an image from a video from an AR headset).

Neural network 1000 includes a number of hidden layers. Both deep learning neural networks (DLNNs) and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 400.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 10A, pixels provided as the input layer are fed as inputs to the J neurons of hidden layer 1. However, in some embodiments, other inputs may be provided, such as locations, audio recordings a person or pet to learn to mimic, text produced by a person to mimic, images, videos, real world models, virtual world models, geofencing constraints, real world object information, etc. While all pixels are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. It should be noted that numbers of neurons I, J, K, and L are not necessarily equal, and thus, any desired number of layers may be used for a given layer of neural network 1000 without deviating from the scope of the invention. Indeed, in certain embodiments, the types of neurons in a given layer and/or between different layers may not all be the same.

Neural network 1000 is trained to provide classification and locations of objects in the image, as well as confidence scores for these predictions as outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be used and the rest may be ignored.

It should be noted that neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative ∞ and positive ∞, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 1010 is shown in FIG. 10B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 1010 may thus be given by:

$$y = f ( x ) {\sum }_{i = 1}^{m} ( {w}_{i} {x}_{i} ) + bias \qquad ( 3 )$$

In this case, neuron 1010 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward function,” is often employed. A reward function explores intermediate transitions and steps with both short-term and long-term rewards to guide the search of a state space and attempt to achieve a goal (e.g., finding the most accurate answers to user inquiries based on associated metrics). During training, various labeled data is fed through neural network 1000. Successful identifications strengthen weights for inputs to neurons, whereas unsuccessful identifications weaken them. A cost function, such as mean square error (MSE) or gradient descent may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to repeatedly adjust the weights so as to minimize the difference between actual output and desired output.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activity functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o−t. This global error is then propagated backwards giving local errors for weight updates with computations similar to, but not exactly the same as, those used for forward propagation. In particular, the backpropagation step typically requires an activity function of the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ' denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), τ denotes the matrix transpose, and oⱼ denotes ƒⱼ (Wⱼoⱼ−1+bⱼ), with o₀=x. Here, the learning rate n is chosen with respect to machine learning considerations. Below, n is related to the neural Hebbian learning mechanism used in the neural implementation. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. This may collectively allow the AI/ML models to perform better than a single model alone.

Some embodiments may use transformer networks such as SentenceTransformers™, which is a Python™ framework for state-of-the-art sentence, text, and image embeddings. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

Natural language processing (NLP) techniques such as word2vec, BERT, GPT-3, Open AI, etc. may be used in some embodiments to facilitate semantic understanding and provide more accurate and human-like answers. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

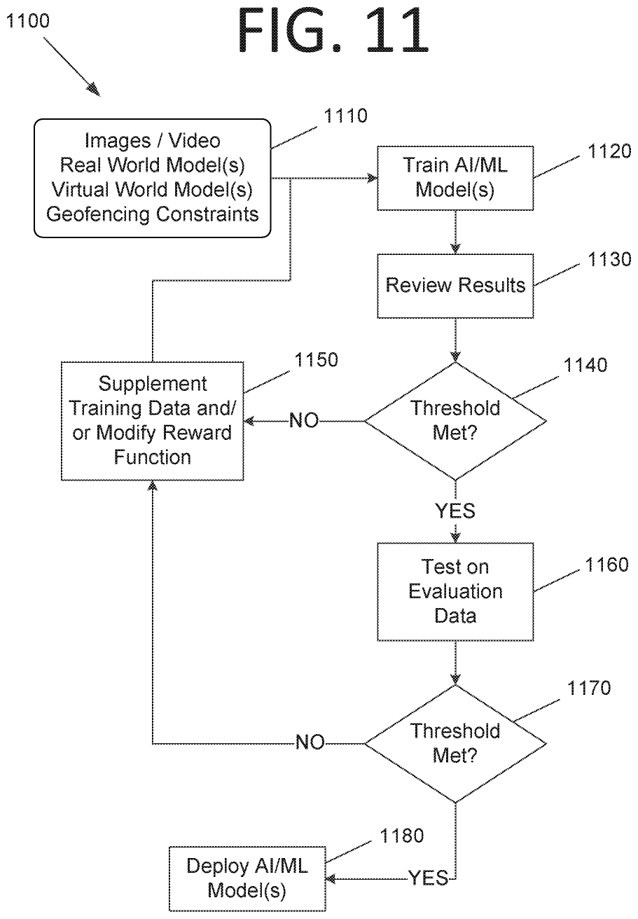

FIG. 11 is a flowchart illustrating a process 1100 for training AI/ML model(s), according to an embodiment of the present invention. In some embodiments, the AI/ML model(s) may be generative AI model(s). The neural network architecture of AI/ML models typically includes multiple layers of neurons, including input, output, and hidden layers. See FIGS. 10A and 10B, for example. The input layer receives the input(s) and the output layer generates the response(s). The hidden layers in between process the input data and generate intermediate representations of the input that are used to generate the output. These hidden layers can include various types of neurons, such as convolutional neurons, recurrent neurons, and/or transformer neurons.

The training process begins with providing images/video, real world model(s) for AR, virtual world models for VR, geofencing constraints, etc., whether labeled or unlabeled, at 1110 to train the AI/ML model(s). The AI/ML model(s) are then trained over multiple epochs at 1120 and results are reviewed at 1130. While various types of AI/ML models may be used, LLMs and other generative AI models are typically trained using a process called “supervised learning”, which is also discussed above. Supervised learning involves providing the model with a large dataset, which the model uses to learn the relationships between the inputs and outputs. During the training process, the model adjusts the weights and biases of the neurons in the neural network to minimize the difference between the predicted outputs and the actual outputs in the training dataset.

One aspect of the models in some embodiments is the use of transfer learning. For instance, transfer learning may take advantage of a pretrained model, such as ChatGPT, which is fine-tuned on a specific task or domain in step 1120. This allows the model to leverage the knowledge already learned from the pretraining phase and adapt it to a specific application via the training phase of step 1120.

The pretraining phase involves training the model on an initial set of training data that may be more general. During this phase, the model learns relationships in the data. In the fine-tuning phase (e.g., performed during step 1120 in addition to or in lieu of the initial training phase in some embodiments if a pretrained model is used as the initial basis for the final model), the pretrained model is adapted to a specific task or domain by training the model on a smaller dataset that is specific to the task. For instance, in some embodiments, the model may be focused on mimicking the behavior of a human or a pet for VR explorer applications. Fine-tuning allows the model to learn the nuances of the task, such as the specific vocabulary and syntax, certain graphical characteristics, certain data formats, etc., without requiring as much data as would be necessary to train the model from scratch. By leveraging the knowledge learned in the pretraining phase, the fine-tuned model can achieve state-of-the-art performance on specific tasks with relatively little additional training data.

If the AI/ML model(s) fail to meet desired confidence threshold(s) at 1140 (i.e., different AI/ML models may have different desired minimum confidence thresholds), the training data is supplemented and/or the reward function is modified to help the AI/ML model(s) achieve their objectives better at 1150 and the process returns to step 1120. If the AI/ML model(s) meet the confidence threshold(s) at 1140, the AI/ML model(s) are tested on evaluation data at 1160 to ensure that the AI/ML model(s) generalize well and that the AI/ML model(s) are not over fit with respect to the training data. The evaluation data includes information that the AI/ML model(s) have not processed before. If the confidence threshold(s) are met at 1170 for the evaluation data, the AI/ML model(s) are deployed at 1180. If not, the process returns to step 1150 and the AI/ML model(s) are trained further.

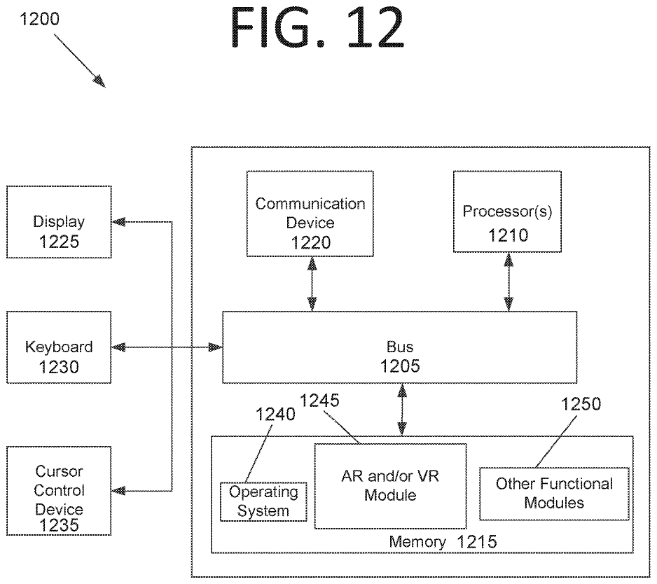

FIG. 12 is an architectural diagram illustrating a computing system 1200 configured to provide combined AR and/or VR with a feedback loop, or aspects thereof, according to an embodiment of the present invention. In some embodiments, computing system 1200 may be one or more of the computing systems depicted and/or described herein, such as those of FIG. 7. Computing system 1200 includes a bus 1205 or other communication mechanism for communicating information, and processor(s) 1210 coupled to bus 1205 for processing information. Processor(s) 1210 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 1210 may also have multiple processing cores, and at least some of the cores may be configured to perform specific functions. Multi-parallel processing may be used in some embodiments. In certain embodiments, at least one of processor(s) 1210 may be a neuromorphic circuit that includes processing elements that mimic biological neurons. In some embodiments, neuromorphic circuits may not require the typical components of a Von Neumann computing architecture.

Computing system 1200 further includes a memory 1215 for storing information and instructions to be executed by processor(s) 1210. Memory 1215 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 1210 and may include volatile media, non-volatile media, or both. The media may also be removable, non-removable, or both.

Additionally, computing system 1200 includes a communication device 1220, such as a transceiver, to provide access to a communications network via a wireless and/or wired connection. In some embodiments, communication device 1220 may be configured to use Frequency Division Multiple Access (FDMA), Single Carrier FDMA (SC-FDMA), Time Division Multiple Access (TDMA), Code Division Multiple Access (CDMA), Orthogonal Frequency Division Multiplexing (OFDM), Orthogonal Frequency Division Multiple Access (OFDMA), Global System for Mobile (GSM) communications, General Packet Radio Service (GPRS), Universal Mobile Telecommunications System (UMTS), cdma2000, Wideband CDMA (W-CDMA), High-Speed Downlink Packet Access (HSDPA), High-Speed Uplink Packet Access (HSUPA), High-Speed Packet Access (HSPA), Long Term Evolution (LTE), LTE Advanced (LTE-A), 802.11x, Wi-Fi, Zigbee, Ultra-WideBand (UWB), 802.16x, 802.15, Home Node-B (HnB), Bluetooth, Radio Frequency Identification (RFID), Infrared Data Association (IrDA), Near-Field Communications (NFC), fifth generation (5G), New Radio (NR), any combination thereof, and/or any other currently existing or future-implemented communications standard and/or protocol without deviating from the scope of the invention. In some embodiments, communication device 1220 may include one or more antennas that are singular, arrayed, phased, switched, beamforming, beamsteering, a combination thereof, and or any other antenna configuration without deviating from the scope of the invention.

Processor(s) 1210 are further coupled via bus 1205 to a display 1225, such as a plasma display, a Liquid Crystal Display (LCD), a Light Emitting Diode (LED) display, a Field Emission Display (FED), an Organic Light Emitting Diode (OLED) display, a flexible OLED display, a flexible substrate display, a projection display, A 4K display, a high definition display, a Retina® display, an In-Plane Switching (IPS) display, or any other suitable display for displaying information to a user. Display 1225 may be configured as a touch (haptic) display, a three-dimensional (3D) touch display, a multi-input touch display, a multi-touch display, etc. using resistive, capacitive, surface-acoustic wave (SAW) capacitive, infrared, optical imaging, dispersive signal technology, acoustic pulse recognition, frustrated total internal reflection, etc. Any suitable display device and haptic I/O may be used without deviating from the scope of the invention.

A keyboard 1230 and a cursor control device 1235, such as a computer mouse, a touchpad, etc., are further coupled to bus 1205 to enable a user to interface with computing system 1200. However, in certain embodiments, a physical keyboard and mouse may not be present, and the user may interact with the device solely through display 1225 and/or a touchpad (not shown). Any type and combination of input devices may be used as a matter of design choice. In certain embodiments, no physical input device and/or display is present. For instance, the user may interact with computing system 1200 remotely via another computing system in communication therewith, or computing system 1200 may operate autonomously.

Memory 1215 stores software modules that provide functionality when executed by processor(s) 1210. The modules include an operating system 1240 for computing system 1200. The modules further include an AR and/or VR module 1245 that is configured to perform all or part of the processes described herein or derivatives thereof. Computing system 1200 may include one or more additional functional modules 1250 that include additional functionality.

One skilled in the art will appreciate that a “computing system” could be embodied as a server, an embedded computing system, a personal computer, a console, a personal digital assistant (PDA), a cell phone, a tablet computing device, a smart watch, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a local area network (LAN), a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

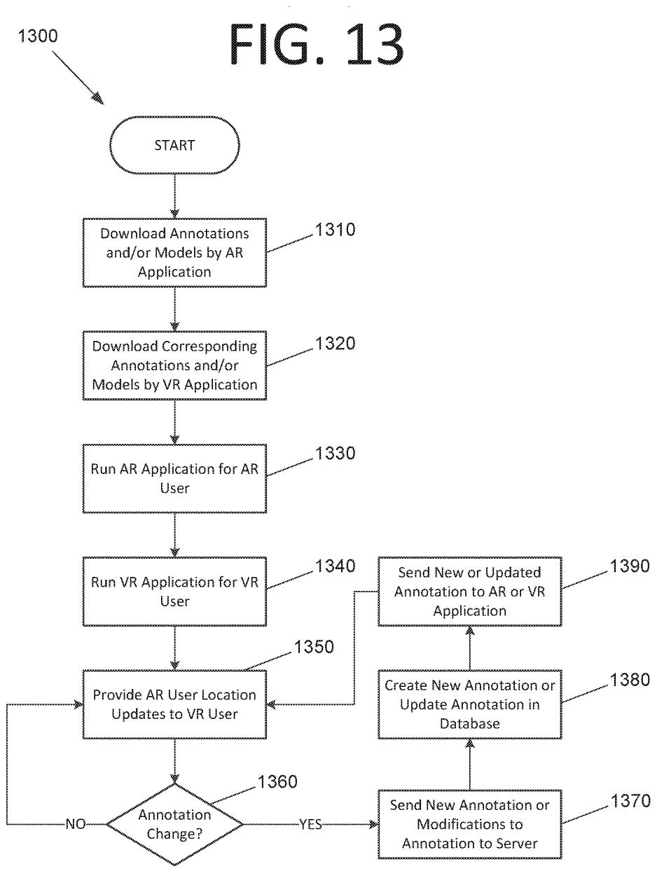

FIG. 13 is a flowchart illustrating a process 1300 for providing combined AR and VR with a feedback loop, or aspects thereof, according to an embodiment of the present invention. The process begins with downloading annotations and/or 3D models by an AR application at 1310 and by a VR application at 1320. An AR user then runs the AR application at 1330 and a VR user runs the VR application at 1340. In some embodiments, the annotations and/or models may be downloaded after the AR application and the VR application begin running. The AR application provides the current location of its user to the VR application at 1350. This may be via GPS initially in some embodiments.

While there are no annotation changes at 1360, the AR application periodically sends location updates at 1350 (e.g., coordinate updates from sensors of the computing system that is running the AR application, allowing “displacement” of the AR explorer from the initial position to be determined). The location updates may be performed by the AR application updating a database and the VR application periodically polling from the database, the VR application receiving updates from the AR application through a publication/subscription system, a direct Transmission Control Protocol/Internet Protocol (TCP/IP) connection between the AR application and the VR application, etc. However, if the AR user or VR user creates a new annotation or modifies an existing annotation, the respective AR application or VR application sends the new or updated annotation to a server at 1370, which stores the new annotation or modified version of the existing annotation in a database at 1380. In some embodiments, the new or updated annotation is then sent to the other of the AR application or the VR application (i.e., the application that did not create or modify the annotation) at 1390 so both the AR application and the VR application have the latest version of the annotations.

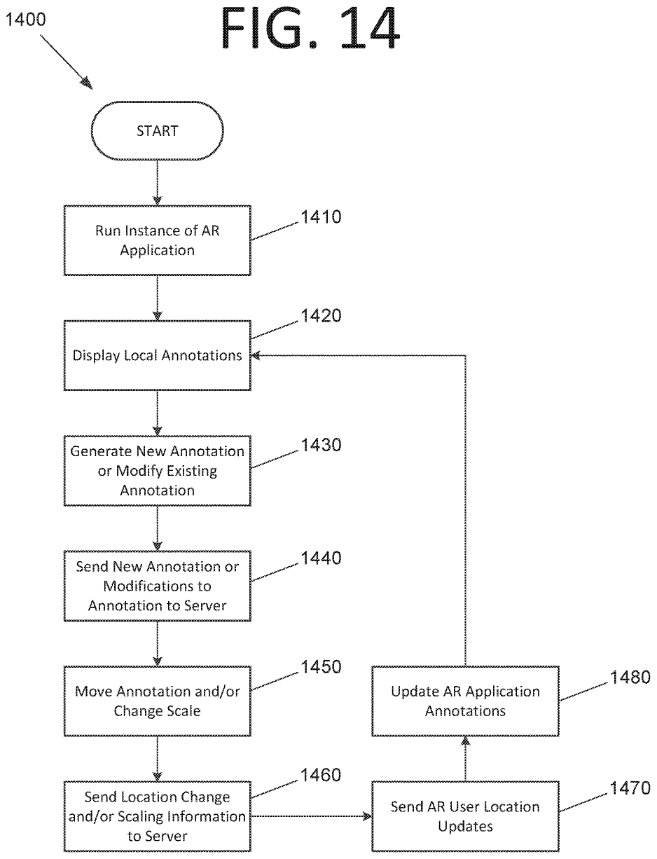

FIG. 14 is a flowchart illustrating a process 1400 for providing AR with a feedback loop, or aspects thereof, according to an embodiment of the present invention. The process begins with running an instance of an AR application at 1410. Annotations local to the AR user are displayed in the AR computing system at 1420. The annotations are linked to one or more respective real world locations as holographic projections. The annotations are linked to the respective real world locations by a coordinate system. The annotations are also associated with corresponding locations in a VR application. For instance, in some embodiments, GPS coordinates for annotations are stored in a database. These annotations may ultimately be converted into a left handed coordinate system such as the Unity™ coordinate system, a right handed coordinate system such as the Blender™ coordinate system, or any other non-GPS coordinate system without deviating from the scope of the invention, to display the annotations to the user, but this position is not necessarily stored in the database since it will change depending on where the AR application is launched from or where the “reference anchor point” is. The geocoordinates, however, typically stay consistent. In some embodiments, the respective locations of the annotations are linked to respective virtual locations in the VR application using respective synthetic square markers (e.g., ArUco markers). In certain embodiments, the annotations include indications of which AR users and VR users made corresponding edits to the annotations and who created the annotations.

When the AR user generates a new annotation or modifies an existing annotation at 1430, the AR application sends the new or modified annotation to a server at 1440 so other instances of the AR application and instances of the VR application can be updated with the new or modified annotation. The AR user may choose to move an annotation and/or change the scale of other annotations relative to a root annotation at 1450. An update pertaining to this action is then sent to the server at 1460 in case such changes need to be made for other AR application instances. The updates of the AR user's current location are sent at 1470, and annotations are updated in the AR application if changed by other users at 1480.

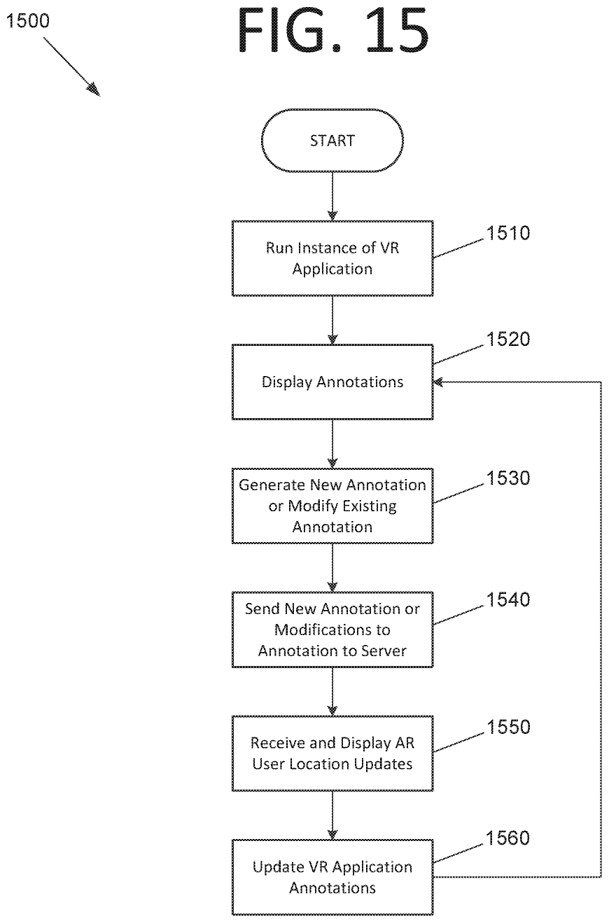

FIG. 15 is a flowchart illustrating a process 1500 for providing VR with a feedback loop, or aspects thereof, according to an embodiment of the present invention. The process begins with running an instance of a VR application at 1510. Annotations local to the virtual location that the VR user is viewing are displayed on the VR computing system at 1520. The annotations correspond to respective real world locations.

When the VR user generates a new annotation or modifies an existing annotation at 1530, the VR application sends the new or modified annotation to a server at 1540 so instances of the AR application and other instances of the VR application can be updated with the new or modified annotation. The updates of an AR user's current location are received and displayed at 1550, and annotations are updated in the VR application if changed by other users at 1560.

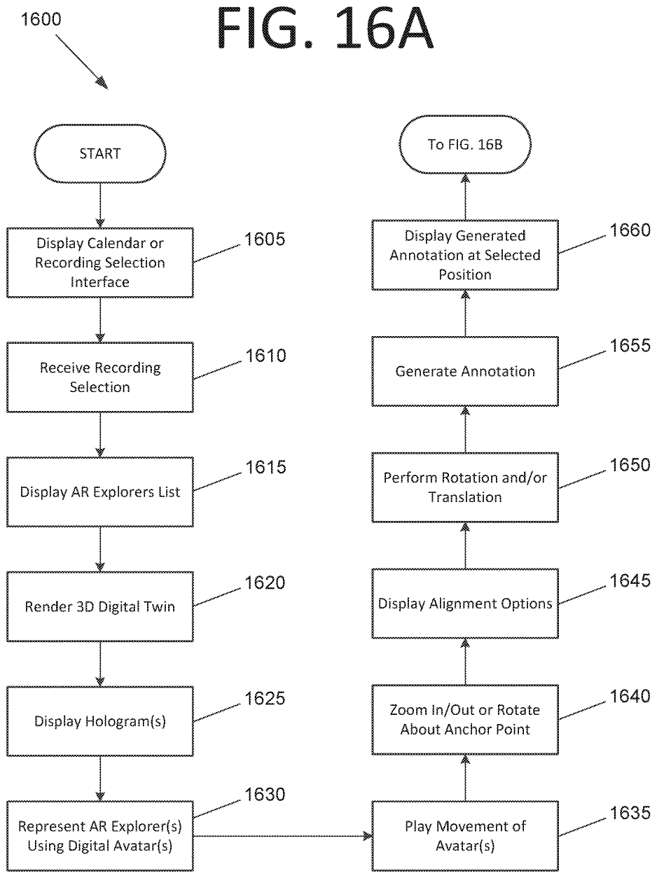

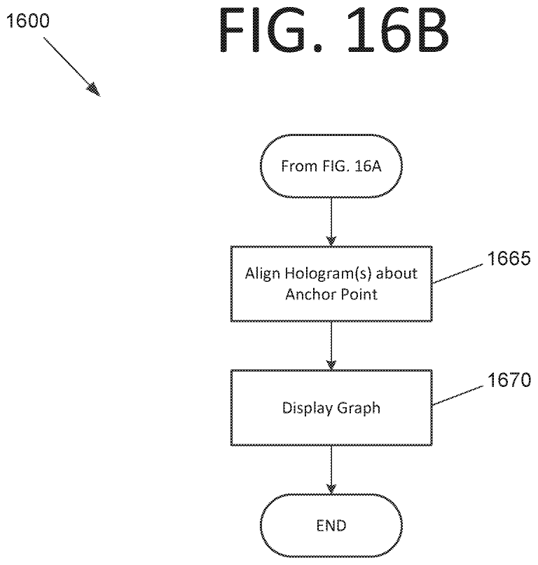

FIGS. 16A and 16B are flowcharts illustrating a process 1600 for using a remote application of a combined AR and remote system configured to facilitate interactions with the virtual world and physical world, according to an embodiment of the present invention. The process begins with displaying a calendar or other recording selection interface at 1605 that allows the remote user to select a recording date and time pertaining to a location. A selection of a recording is received at 1610 and a list including the AR explorers that were present that the location at the time of the recording is displayed at 1615.

A 3D digital twin of the selected location that AR explorer(s) either are currently visiting or previously visited is rendered at 1620. Hologram(s) pertaining to the location are displayed at 1625. The hologram(s) are each placed by an AR explorer or a virtual user. The AR explorer(s) are represented in the 3D digital twin using respective avatar(s) at 1630. Movement of the avatar(s) is played at 1635 by showing path(s) taken by the AR explorer(s) and directions that the AR explorer was looking at various times during the recording.

The remote user zooms in or out or rotates about an anchor point in the 3D digital twin at 1640. Alignment options including at least one of rotation controls and translation controls are displayed at 1645. Rotation and/or translation is performed at 1650 responsive to manipulation of the rotation controls and/or translation controls by the remote user.

An annotation is generated at 1655 responsive to input from an AR explorer or the remote user. The annotation includes a text memo, a voice recording, and/or a video. The generated annotation is then displayed at a position selected by the AR explorer or the remote user in the 3D digital twin at 1660. Hologram(s) are aligned in the 3D digital twin about an anchor point at 1665 by rotating and/or moving the plurality of holograms closer to or further from the anchor point. A graph is displayed at 1670 representing a path that the AR explorer took, directions in which the AR explorer looked, biometrics over time, or a heat map of where the AR explorer visited at the location.

In some embodiments, coordinates of where the AR explorer visited are obtained initially using a GNSS and relative positions to GNSS coordinates afterwards. In certain embodiments, locations of the displayed one or more holograms are aligned between real and virtual worlds by the AR explorer and the remote application uses the virtual world alignments. In some embodiments, the hologram(s) include a 3D model of an object and/or an animation.

The process steps performed in FIGS. 11 and 13-16B may be performed by computer program(s), encoding instructions for the processor(s) to perform at least part of the process(es) described in FIGS. 11 and 13-16B, in accordance with embodiments of the present invention. The computer program(s) may be embodied on non-transitory computer-readable media. The computer-readable media may be, but are not limited to, a hard disk drive, a flash device, RAM, a tape, and/or any other such medium or combination of media used to store data. The computer program(s) may include encoded instructions for controlling processor(s) of computing system(s) (e.g., processor(s) 1210 of computing system 1200 of FIG. 12) to implement all or part of the process steps described in FIGS. 11 and 13-16B, which may also be stored on the computer-readable medium.

The computer program(s) can be implemented in hardware, software, or a hybrid implementation. The computer program(s) can be composed of modules that are in operative communication with one another, and which are designed to pass information or instructions to display. The computer program(s) can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs for a remote application for a combined augmented reality (AR) and remote system, the one or more computer programs configured to cause the at least one processor to:
render a three-dimensional (3D) digital twin of a location that an AR explorer either is currently visiting or previously visited;
display one or more holograms pertaining to the location, the one or more holograms placed by at least one of the AR explorer and a virtual user;
represent the AR explorer in the 3D digital twin using an avatar; and
play movement of the avatar by showing a path taken by the AR explorer and a direction in which the AR explorer was looking at various times during the recording.

2. The one or more non-transitory computer-readable media of claim 1, wherein the one or more computer programs are further configured to cause the at least one processor to:
display a calendar or other recording selection interface that allows the remote user to select a recording date and time pertaining to the location; and
perform the rendering of the 3D digital twin accordingly.

3. The one or more non-transitory computer-readable media of claim 1, wherein the one or more computer programs are further configured to cause the at least one processor to:
display a list comprising the AR explorer and one or more other AR explorers that were present that the location at a same time as the AR explorer.

4. The one or more non-transitory computer-readable media of claim 1, wherein the one or more computer programs are further configured to cause the at least one processor to:
zoom in or out or rotate about an anchor point in the 3D digital twin responsive to input from the remote user.

5. The one or more non-transitory computer-readable media of claim 1, wherein the one or more computer programs are further configured to cause the at least one processor to:
display alignment options comprising at least one of rotation controls and translation controls; and
perform at least one of rotation and translation responsive to manipulation of the rotation controls and/or translation controls by the remote user.

6. The one or more non-transitory computer-readable media of claim 1, wherein the one or more computer programs are further configured to cause the at least one processor to:
generate an annotation responsive to input from the AR explorer or the remote user, the annotation comprising at least one of a text memo, a voice recording, a hologram, and a video; and
display the generated annotation at a position selected by the AR explorer or the remote user in the 3D digital twin.

7. The one or more non-transitory computer-readable media of claim 1, wherein the one or more computer programs are further configured to cause the at least one processor to:
align a plurality of holograms in the 3D digital twin about an anchor point by at least one of rotating and moving the plurality of holograms closer to or further from the anchor point.

8. The one or more non-transitory computer-readable media of claim 1, wherein the one or more computer programs are further configured to cause the at least one processor to:
display a graph representing a path that the AR explorer took, directions in which the AR explorer looked, biometrics over time, or a heat map of where the AR explorer visited at the location.

9. The one or more non-transitory computer-readable media of claim 1, wherein coordinates of where the AR explorer visited are obtained initially using a global navigation satellite system (GNSS) and relative positions to GNSS coordinates afterwards.

10. The one or more non-transitory computer-readable media of claim 1, wherein
locations of the displayed one or more holograms are aligned between real and virtual worlds by the AR explorer, and
the remote application uses the virtual world alignments.

11. The one or more non-transitory computer-readable media of claim 1, wherein the one or more holograms comprise at least one of a 3D model of an object and an animation.

12. A computer-implemented for a remote application of a combined augmented reality (AR) and remote system, comprising:
rendering, by a computing system, a three-dimensional (3D) digital twin of a location that an augmented reality (AR) explorer either is currently visiting or previously visited;
displaying, by the computing system, one or more holograms pertaining to the location, the one or more holograms placed by at least one of the AR explorer and a virtual user;
representing the AR explorer in the 3D digital twin using an avatar, by the computing system;
playing, by the computing system, movement of the avatar by showing a path taken by the AR explorer and a direction in which the AR explorer was looking at various times during the recording;
displaying, by the computing system, alignment options comprising at least one of rotation controls and translation controls; and
performing, by the computing system, at least one of rotation and translation responsive to manipulation of the rotation controls and/or translation controls by the remote user.

13. The computer-implemented method of claim 12, further comprising:
zooming in or out or rotating about an anchor point in the 3D digital twin, by the computing system, responsive to input from the remote user.

14. The computer-implemented method of claim 12, further comprising:
generating an annotation, by the computing system, responsive to input from the AR explorer or the remote user, the annotation comprising at least one of a text memo, a voice recording, a hologram, and a video; and
displaying the generated annotation, by the computing system, at a position selected by the AR explorer or the remote user in the 3D digital twin.

15. The computer-implemented method of claim 12, further comprising:
aligning, by the computing system, a plurality of holograms in the 3D digital twin about an anchor point by at least one of rotating and moving the plurality of holograms closer to or further from the anchor point.

16. The computer-implemented method of claim 12, further comprising:
displaying, by the computing system, a graph representing a path that the AR explorer took, directions in which the AR explorer looked, biometrics over time, or a heat map of where the AR explorer visited at the location.

17. The computer-implemented method of claim 12, wherein
locations of the displayed one or more holograms are aligned between real and virtual worlds by the AR explorer, and
the remote application uses the virtual world alignments.

18. One or more computing systems, comprising:
memory storing computer program instructions for a remote application for a combined augmented reality (AR) and remote system; and
at least one processor configured to execute the computer program instructions, wherein the computer program instructions are configured to cause the at least one processor to:
render a three-dimensional (3D) digital twin of a location that an AR explorer either is currently visiting or previously visited,
display one or more holograms pertaining to the location, the one or more holograms placed by at least one of the AR explorer and a virtual user,
represent the AR explorer in the 3D digital twin using an avatar, and
play movement of the avatar by showing a path taken by the AR explorer and a direction in which the AR explorer was looking at various times during the recording.

19. The one or more computing systems of claim 18, wherein the computer program instructions are further configured to cause the at least one processor to:
generate an annotation responsive to input from the AR explorer or the remote user, the annotation comprising at least one of a text memo, a voice recording, a hologram, and a video; and
display the generated annotation at a position selected by the AR explorer or the remote user in the 3D digital twin.

20. The one or more computing systems of claim 18, wherein the computer program instructions are further configured to cause the at least one processor to:
align a plurality of holograms in the 3D digital twin about an anchor point by at least one of rotating and moving the plurality of holograms closer to or further from the anchor point.
